(19) United States
(12) Patent Application Publication
(10) Pub. No.: US 2023/0180220 A1
(43) Pub. Date: Jun. 8, 2023

(54) UPLINK DOWNLINK CONTROL INFORMATION FOR SCHEDULING MULTIPLE COMPONENT CARRIERS

(71) Applicant: QUALCOMM Incorporated, San Diego, CA (US)

(72) Inventors: Kazuki TAKEDA, Tokyo (JP); Wanshi CHEN, San Diego, CA (US); Peter GAAL, San Diego, CA (US); Tao LUO, San Diego, CA (US); Xiaoxia ZHANG, San Diego, CA (US); Alberto RICO ALVARINO, San Diego, CA (US); Mostafa KHOSHNEVISAN, San Diego, CA (US); Yiqing CAO, Beijing (CN)

(21) Appl. No.: 17/906,440

(22) PCT Filed: Apr. 15, 2021
(86) PCT No.: PCT/CN2021/087532

§ 371 Date: Sep. 15, 2022

(30) Foreign Application Priority Data
May 15, 2020 (CN) PCT/CN2020/090464

(51) Int. Cl. H04W 72/1268; H04W 72/20

(52) U.S. Cl. CPC H04W 72/1268; H04W 72/20

(57) ABSTRACT

Methods, systems, and devices for wireless communications are described. A user equipment (UE) may receive a downlink control information (DCI) message associated with scheduling uplink transmissions from the UE on a set of component carriers (CCs). The DCI message may indicate that a first uplink channel on a first CC of the set of CCs at least partially overlaps in time with a second uplink channel on a second CC of the set of CCs. The UE may multiplex, based on the first uplink channel at least partially overlapping in time with the second uplink channel, uplink control information (UCI) with an uplink data transmission on the first CC or the second CC. The UE may transmit the UCI and the uplink data transmission multiplexed on the first CC or the second CC based at least in part on the DCI message.

### CROSS REFERENCE

The present Application is a 371 national stage filing of International PCT Application No. PCT/CN2021/087532 by Takeda et al. entitled “UPLINK DOWNLINK CONTROL INFORMATION FOR SCHEDULING MULTIPLE COMPONENT CARRIERS,” filed Apr. 15, 2021; and claims priority to PCT Application No. PCT/CN2020/090464 by Takeda et al., entitled “UPLINK DOWNLINK CONTROL INFORMATION FOR SCHEDULING MULTIPLE COMPONENT CARRIERS,” filed May 15, 2020, each of which is assigned to the assignee hereof, and each of which is expressly incorporated by reference in its entirety herein.

### FIELD OF TECHNOLOGY

The following relates generally to wireless communications and more specifically to uplink downlink control information for scheduling multiple component carriers.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support uplink downlink control information (DCI) for scheduling multiple component carriers (CCs). Generally, the described techniques provide various mechanisms that support uplink control information (UCI) being multiplexed on an uplink data transmission (e.g., uplink data communicated over a physical uplink shared channel (PUSCH)) on one or more CCs of a plurality of CCs. For example, a base station may identify or otherwise determine that UCI and the uplink data transmission are to be multiplexed on a first CC (e.g., CC1) or a second CC (e.g., CC2) of the multiple CCs. The base station may determine this for a UE. Accordingly, the base station may transmit or otherwise convey a DCI message to the UE that is for or otherwise associated with scheduling uplink transmissions from the UE (e.g., an uplink DCI scheduling PUSCH transmissions on multiple CCs). In some aspects, the DCI message may carry or otherwise convey an indication that a first uplink channel (e.g., a first PUSCH, or PUSCH1) on CC1 at least partially overlaps in the time domain with a second uplink channel (e.g., a second PUSCH, or PUSCH2) on CC2. This may indicate that UCI multiplexing is supported for the uplink transmissions. That is, the base station may implement a scheduling constraint such that PUSCH1 and PUSCH2 overlap at least some degree in the time domain. For example, PUSCH1 and PUSCH2 may completely overlap in the time domain or may partially overlap in the time domain. This scheduling constraint adopted by the base station may explicitly or implicitly indicate that the UE can multiplex UCI with the uplink data transmission on CC1 (e.g., PUSCH1) or with the uplink data transmission on CC2 (e.g., PUSCH2). Accordingly, the UE may receive the DCI and, based on the indication of the overlapping PUSCH transmissions, multiplex UCI with an uplink data transmission on CC1 or CC2. The UE may transmit the multiplexed UCI and uplink data transmission on the corresponding CC1 or CC2, e.g., the UCI multiplexed in PUSCH1 on CC1 or the UCI multiplexed on PUSCH2 on CC2.

Additionally or alternatively, aspects of the described techniques may support separate fields in the DCI message being used to identify that UCI multiplexing is supported on PUSCH1 on CC1 or on PUSCH2 CC2. For example, the base station may configure a first subset of fields associated with CC1 or a second subset of fields associated with CC2 of the DCI message to indicate multiplexing information for multiplexing UCI with an uplink data transmission on CC1 or with the uplink data transmission on CC2. Examples of the subsets of fields may include, but is not limited to, downlink assignment indicator (DAI) fields, beta offset fields, channel state information (CSI) fields, uplink scheduling indicator (UL-SCH) fields, and the like. The base station may transmit or otherwise convey the DCI message to the UE indicating that UCI multiplexing is supported for the uplink data transmissions on CC1 or CC2. The UE may determine that UCI multiplexing is supported based on the DCI message, and multiplex the UCI with the uplink data transmission on CC1 or on CC2. The UE may then transmit the multiplexed UCI/PUSCH on CC1 or CC2 to the base station.

A method of wireless communication at a UE is described. The method may include receiving a DCI message associated with scheduling uplink transmissions from the UE on a set of CCs, the DCI message indicating that a first uplink channel on a first CC of the set of CCs at least partially overlaps in time with a second uplink channel on a second CC of the set of CCs, multiplexing, based on the first uplink channel at least partially overlapping in time with the second uplink channel, UCI with an uplink data transmission on the first CC or the second CC, and transmitting the UCI and the uplink data transmission multiplexed on the first CC or the second CC based at least in part on the DCI message.

An apparatus for wireless communication at a UE is described. The apparatus may include a processor, memory coupled with the processor, and instructions stored in the memory. The instructions may be executable by the processor to cause the apparatus to receive a DCI message associated with scheduling uplink transmissions from the UE on a set of CCs, the DCI message indicating that a first uplink channel on a first CC of the set of CCs at least partially overlaps in time with a second uplink channel on a second CC of the set of CCs, that UCI multiplexing is supported for the uplink transmissions, multiplex, based on the first uplink channel at least partially overlapping in time with the second uplink channel, UCI with an uplink data transmission on the first CC or the second CC, and transmit the UCI and the uplink data transmission multiplexed on the first CC or the second CC based at least in part on the DCI message.

Another apparatus for wireless communication at a UE is described. The apparatus may include means for receiving a DCI message associated with scheduling uplink transmissions from the UE on a set of CCs, the DCI message indicating that a first uplink channel on a first CC of the set of CCs at least partially overlaps in time with a second uplink channel on a second CC of the set of CCs, multiplexing, based on the first uplink channel at least partially overlapping in time with the second uplink channel, UCI with an uplink data transmission on the first CC or the second CC, and transmitting the UCI and the uplink data transmission multiplexed on the first CC or the second CC based at least in part on the DCI message.

A non-transitory computer-readable medium storing code for wireless communication at a UE is described. The code may include instructions executable by a processor to receive a DCI message associated with scheduling uplink transmissions from the UE on a set of CCs, the DCI message indicating that a first uplink channel on a first CC of the set of CCs at least partially overlaps in time with a second uplink channel on a second CC of the set of CCs, multiplex, based on the first uplink channel at least partially overlapping in time with the second uplink channel, UCI with an uplink data transmission on the first CC or the second CC, and transmit the UCI and the uplink data transmission multiplexed on the first CC or the second CC based at least in part on the DCI message.

Some examples of the method, apparatuses, and non-transitory computer-readable medium described herein may further include operations, features, means, or instructions for determining that the DCI message indicates that the first uplink channel on the first CC at least partially overlaps in time with the second uplink channel on the second CC based on one or more TDRA fields of the DCI message.

Some examples of the method, apparatuses, and non-transitory computer-readable medium described herein may further include operations, features, means, or instructions for identifying, based on the DCI message, a first TDRA entry indicated in a first TDRA field, identifying, based on the DCI message, a second TDRA entry indicated in a second TDRA field, and determining, based on the first TDRA entry and the second TDRA entry, that the first uplink channel on the first CC at least partially overlaps in time with the second uplink channel on the second CC.

Some examples of the method, apparatuses, and non-transitory computer-readable medium described herein may further include operations, features, means, or instructions for identifying a first TDRA field in the DCI message indicating a first uplink transmission timing for the first CC and a second TDRA field in the DCI message indicating a second uplink transmission timing, where the first uplink transmission timing at least partially overlaps in time with the second uplink transmission timing.

Some examples of the method, apparatuses, and non-transitory computer-readable medium described herein may further include operations, features, means, or instructions for multiplexing the UCI with the uplink data transmission on the first CC or the second CC based on a subset of fields indicated in the DCI message.

In some examples of the method, apparatuses, and non-transitory computer-readable medium described herein, the UCI includes acknowledgment feedback information, or CSI, or a scheduling request, or a combination thereof.

In some examples of the method, apparatuses, and non-transitory computer-readable medium described herein, the first uplink channel at least partially overlapping in time with the second uplink channel includes the first uplink channel fully overlapping at least a portion of the second uplink channel.

In some examples of the method, apparatuses, and non-transitory computer-readable medium described herein, the first uplink channel at least partially overlapping in time with the second uplink channel includes the first uplink channel fully overlapping the second uplink channel, and the second uplink channel fully overlapping the first uplink channel.

In some examples of the method, apparatuses, and non-transitory computer-readable medium described herein, the first uplink channel uses a first symbol duration, and the second uplink channel uses a second symbol duration different than the first symbol duration.

A method of wireless communication at a UE is described. The method may include receiving a DCI message associated with scheduling uplink transmissions from the UE on a set of CCs, the DCI message indicating a first uplink channel on a first CC of the set of CCs and a second uplink channel on a second CC of the set of CCs, multiplexing, based at least in part on the first uplink channel at least partially overlapping in time with the second uplink channel, UCI with an uplink data transmission on the first CC according to a first subset of fields associated with the first CC in the DCI message or the UCI with the uplink data transmission on the second CC according to a second subset of fields associated with the second CC in the DCI message, and transmitting the UCI and the uplink data transmission multiplexed on the first CC or the second CC based at least in part on the DCI message.

An apparatus for wireless communication at a UE is described. The apparatus may include a processor, memory coupled with the processor, and instructions stored in the memory. The instructions may be executable by the processor to cause the apparatus to receive a DCI message associated with scheduling uplink transmissions from the UE on a set of CCs, the DCI message indicating a first uplink channel on a first CC of the set of CCs and a second uplink channel on a second CC of the set of CCs, multiplex, based at least in part on the first uplink channel at least partially overlapping in time with the second uplink channel, UCI with an uplink data transmission on the first CC according to a first subset of fields associated with the first CC in the DCI message or the UCI with the uplink data transmission on the second CC according to a second subset of fields associated with the second CC in the DCI message, and transmit the UCI and the uplink data transmission multiplexed on the first CC or the second CC based at least in part on the DCI message.

Another apparatus for wireless communication at a UE is described. The apparatus may include means for receiving a DCI message associated with scheduling uplink transmissions from the UE on a set of CCs, the DCI message indicating a first uplink channel on a first CC of the set of CCs and a second uplink channel on a second CC of the set of CCs, multiplexing, based at least in part on the first uplink channel at least partially overlapping in time with the second uplink channel, UCI with an uplink data transmission on the first CC according to a first subset of fields associated with the first CC in the DCI message or the UCI with the uplink data transmission on the second CC according to a second subset of fields associated with the second CC in the DCI message, and transmitting the UCI and the uplink data transmission multiplexed on the first CC or the second CC based at least in part on the DCI message.

A non-transitory computer-readable medium storing code for wireless communication at a UE is described. The code may include instructions executable by a processor to receive a DCI message associated with scheduling uplink transmissions from the UE on a set of CCs, the DCI message indicating a first uplink channel on a first CC of the set of CCs and a second uplink channel on a second CC of the set of CCs, multiplex, based at least in part on the first uplink channel at least partially overlapping in time with the second uplink channel, UCI with an uplink data transmission on the first CC according to a first subset of fields associated with the first CC in the DCI message or the UCI with the uplink data transmission on the second CC according to a second subset of fields associated with the second CC in the DCI message, and transmit the UCI and the uplink data transmission multiplexed on the first CC or the second CC based at least in part on the DCI message.

Some examples of the method, apparatuses, and non-transitory computer-readable medium described herein may further include operations, features, means, or instructions for determining, based on the DCI message, that the first uplink channel on the first CC at least partially overlaps in time with the second uplink channel on the second CC.

In some examples of the method, apparatuses, and non-transitory computer-readable medium described herein, the first subset of fields associated with the first CC and the second subset of fields associated with the second CC indicate a same set of values.

In some examples of the method, apparatuses, and non-transitory computer-readable medium described herein, one of the first subset of fields associated with the first CC or the second subset of fields associated with the second CC may be used to multiplex the UCI and the uplink data transmission.

In some examples of the method, apparatuses, and non-transitory computer-readable medium described herein, the first subset of fields associated with the first CC may be used to multiplex the UCI and the uplink data transmission and the second subset of fields associated with the second CC indicate a fixed set of values.

In some examples of the method, apparatuses, and non-transitory computer-readable medium described herein, the second subset of fields associated with the second CC may be used to multiplex the UCI and the uplink data transmission and the first subset of fields associated with the first CC indicate a fixed set of values.

In some examples of the method, apparatuses, and non-transitory computer-readable medium described herein, the first subset of fields associated with the first CC may be used to multiplex the UCI and the uplink data transmission and the second subset of fields associated with the second CC may be configured as complementary bits.

In some examples of the method, apparatuses, and non-transitory computer-readable medium described herein, the second subset of fields associated with the second CC may be used to multiplex the UCI and the uplink data transmission and the first subset of fields associated with the first CC may be configured as complementary bits.

In some examples of the method, apparatuses, and non-transitory computer-readable medium described herein, the UCI includes acknowledgment feedback information, or CSI, or a scheduling request, or a combination thereof.

In some examples of the method, apparatuses, and non-transitory computer-readable medium described herein, the first subset of fields include a first DAI field and a first beta offset field associated with the first CC, and the second subset of fields include a second DAI field and a second beta offset field associated with the second CC.

In some examples of the method, apparatuses, and non-transitory computer-readable medium described herein, the first CC may be configured as a time division duplexing carrier, and the second CC may be configured as a frequency division duplexing carrier.

A method of wireless communication at a base station is described. The method may include transmitting a DCI message associated with scheduling uplink transmissions from the UE on the set of CCs, the DCI message indicating that a first uplink channel on a first CC of the set of CCs at least partially overlaps in time with a second uplink channel on a second CC of the set of CCs to indicate that UCI multiplexing is supported for the uplink data transmission, and receiving the UCI and the uplink data transmission multiplexed on the first CC or the second CC based at least in part on the DCI message.

An apparatus for wireless communication at a base station is described. The apparatus may include a processor, memory coupled with the processor, and instructions stored in the memory. The instructions may be executable by the processor to cause the apparatus to transmit a DCI message associated with scheduling uplink transmissions from the UE on the set of CCs, the DCI message indicating that a first uplink channel on a first CC of the set of CCs at least partially overlaps in time with a second uplink channel on a second CC of the set of CCs to indicate that UCI multiplexing is supported for the uplink data transmission, and receive the UCI and the uplink data transmission multiplexed on the first CC or the second CC based at least in part on the DCI message.

Another apparatus for wireless communication at a base station is described. The apparatus may include means for transmitting a DCI message associated with scheduling uplink transmissions from the UE on the set of CCs, the DCI message indicating that a first uplink channel on a first CC of the set of CCs at least partially overlaps in time with a second uplink channel on a second CC of the set of CCs to indicate that UCI multiplexing is supported for the uplink data transmission, and receiving the UCI and the uplink data transmission multiplexed on the first CC or the second CC based at least in part on the DCI message.

A non-transitory computer-readable medium storing code for wireless communication at a base station is described. The code may include instructions executable by a processor to transmit a DCI message associated with scheduling uplink transmissions from the UE on the set of CCs, the DCI message indicating that a first uplink channel on a first CC of the set of CCs at least partially overlaps in time with a second uplink channel on a second CC of the set of CCs to indicate that UCI multiplexing is supported for the uplink data transmission, and receive the UCI and the uplink data transmission multiplexed on the first CC or the second CC based at least in part on the DCI message.

Some examples of the method, apparatuses, and non-transitory computer-readable medium described herein may further include operations, features, means, or instructions for configuring a TDRA field of the DCI message to indicate that the first uplink channel on the first CC at least partially overlaps in time with the second uplink channel on the second CC.

Some examples of the method, apparatuses, and non-transitory computer-readable medium described herein may further include operations, features, means, or instructions for configuring a first TDRA entry indicated in a first TDRA field in the DCI message, and configuring a second TDRA entry indicated in a second TDRA field in the DCI message, where the first TDRA entry and the second TDRA entry indicate that the first uplink channel on the first CC at least partially overlaps in time with the second uplink channel on the second CC.

Some examples of the method, apparatuses, and non-transitory computer-readable medium described herein may further include operations, features, means, or instructions for configuring a first TDRA field in the DCI message to indicate a first uplink transmission timing for the first CC and a second TDRA field in the DCI message to indicate a second uplink transmission timing, where the first uplink transmission timing at least partially overlaps in time with the second uplink transmission timing.

Some examples of the method, apparatuses, and non-transitory computer-readable medium described herein may further include operations, features, means, or instructions for configuring a subset of fields indicate in the DCI message to indicate information associated with multiplexing the UCI with the uplink data transmission on the first CC or the second CC.

In some examples of the method, apparatuses, and non-transitory computer-readable medium described herein, the UCI includes acknowledgment feedback information, or CSI, or a scheduling request, or a combination thereof.

In some examples of the method, apparatuses, and non-transitory computer-readable medium described herein, the first uplink channel at least partially overlapping in time with the second uplink channel includes the first uplink channel fully overlapping at least a portion of the second uplink channel.

In some examples of the method, apparatuses, and non-transitory computer-readable medium described herein, the first uplink channel at least partially overlapping in time with the second uplink channel includes the first uplink channel fully overlapping the second uplink channel, and the second uplink channel fully overlapping the first uplink channel.

In some examples of the method, apparatuses, and non-transitory computer-readable medium described herein, the first uplink channel uses a first symbol duration, and the second uplink channel uses a second symbol duration different than the first symbol duration.

A method of wireless communication at a base station is described. The method may include configuring a first subset of fields associated with a first CC in a DCI message or a second subset of fields associated with a second CC in the DCI message to indicate multiplexing information for multiplexing UCI with an uplink data transmission on the first CC or with the uplink data transmission on the second CC, transmitting, to a UE, the DCI message associated with scheduling uplink transmissions from the UE on a set of CCs, the DCI message indicating that a first uplink channel on the first CC of the set of CCs and a second uplink channel on a second CC of the set of CCs are configured to indicate that UCI multiplexing is supported for the uplink transmissions, and receiving the UCI and the uplink data transmission multiplexed on the first CC or the second CC based at least in part on the DCI message.

An apparatus for wireless communication at a base station is described. The apparatus may include a processor, memory coupled with the processor, and instructions stored in the memory. The instructions may be executable by the processor to cause the apparatus to configure a first subset of fields associated with a first CC in a DCI message or a second subset of fields associated with a second CC in the DCI message to indicate multiplexing information for multiplexing UCI with an uplink data transmission on the first CC or with the uplink data transmission on the second CC, transmit, to a UE, the DCI message associated with scheduling uplink transmissions from the UE on a set of CCs, the DCI message indicating that a first uplink channel on the first CC of the set of CCs and a second uplink channel on a second CC of the set of CCs are configured to indicate that UCI multiplexing is supported for the uplink transmissions, and receive the UCI and the uplink data transmission multiplexed on the first CC or the second CC based at least in part on the DCI message.

Another apparatus for wireless communication at a base station is described. The apparatus may include means for configuring a first subset of fields associated with a first CC in a DCI message or a second subset of fields associated with a second CC in the DCI message to indicate multiplexing information for multiplexing UCI with an uplink data transmission on the first CC or with the uplink data transmission on the second CC, transmitting, to a UE, the DCI message associated with scheduling uplink transmissions from the UE on a set of CCs, the DCI message indicating that a first uplink channel on the first CC of the set of CCs and a second uplink channel on a second CC of the set of CCs are configured to indicate that UCI multiplexing is supported for the uplink transmissions, and receiving the UCI and the uplink data transmission multiplexed on the first CC or the second CC based at least in part on the DCI message.

A non-transitory computer-readable medium storing code for wireless communication at a base station is described. The code may include instructions executable by a processor to configure a first subset of fields associated with a first CC in a DCI message or a second subset of fields associated with a second CC in the DCI message to indicate multiplexing information for multiplexing UCI with an uplink data transmission on the first CC or with the uplink data transmission on the second CC, transmit, to a UE, the DCI message associated with scheduling uplink transmissions from the UE on a set of CCs, the DCI message indicating that a first uplink channel on the first CC of the set of CCs and a second uplink channel on a second CC of the set of CCs are configured to indicate that UCI multiplexing is supported for the uplink transmissions, and receive the UCI and the uplink data transmission multiplexed on the first CC or the second CC based at least in part on the DCI message.

Some examples of the method, apparatuses, and non-transitory computer-readable medium described herein may further include operations, features, means, or instructions for configuring the DCI message to indicate that the first uplink channel on the first CC at least partially overlaps in time with the second uplink channel on a second CC.

In some examples of the method, apparatuses, and non-transitory computer-readable medium described herein, the first subset of fields associated with the first CC and the second subset of fields associated with the second CC indicate a same set of values.

In some examples of the method, apparatuses, and non-transitory computer-readable medium described herein, one of the first subset of fields associated with the first CC or the second subset of fields associated with the second CC may be used by the UE to multiplex the UCI and the uplink data transmission.

In some examples of the method, apparatuses, and non-transitory computer-readable medium described herein, the first subset of fields associated with the first CC may be used by the UE to multiplex the UCI and the uplink data transmission and the second subset of fields associated with the second CC indicate a fixed set of values.

In some examples of the method, apparatuses, and non-transitory computer-readable medium described herein, the second subset of fields associated with the second CC may be used by the UE to multiplex the UCI and the uplink data transmission and the first subset of fields associated with the first CC indicate a fixed set of values.

In some examples of the method, apparatuses, and non-transitory computer-readable medium described herein, the first subset of fields associated with the first CC may be used to multiplex the UCI and the uplink data transmission and the second subset of fields associated with the second CC may be configured as complementary bits.

In some examples of the method, apparatuses, and non-transitory computer-readable medium described herein, the second subset of fields associated with the second CC may be used to multiplex the UCI and the uplink data transmission and the first subset of fields associated with the first CC may be configured as complementary bits.

In some examples of the method, apparatuses, and non-transitory computer-readable medium described herein, the UCI includes acknowledgment feedback information, or CSI, or a scheduling request, or a combination thereof.

In some examples of the method, apparatuses, and non-transitory computer-readable medium described herein, the first subset of fields include a first DAI field and a first beta offset field associated with the first CC, and the second subset of fields include a second DAI field and a second beta offset field associated with the second CC.

In some examples of the method, apparatuses, and non-transitory computer-readable medium described herein, the first CC may be configured as a time division duplexing carrier, and the second CC may be configured as a frequency division duplexing carrier.

### BRIEF DESCRIPTION OF THE DRAWINGS

FIG. 1 illustrates an example of a system for wireless communications that supports uplink downlink control information for scheduling multiple component carriers in accordance with aspects of the present disclosure.

FIG. 2 illustrates an example of a CC configuration that supports uplink downlink control information for scheduling multiple component carriers in accordance with aspects of the present disclosure.

FIGS. 3A through 3C illustrate examples of a CC configuration that supports uplink downlink control information for scheduling multiple component carriers in accordance with aspects of the present disclosure.

FIG. 4 illustrates an example of a CC configuration that supports uplink downlink control information for scheduling multiple component carriers in accordance with aspects of the present disclosure.

FIG. 5 illustrates an example of a CC configuration that supports uplink downlink control information for scheduling multiple component carriers in accordance with aspects of the present disclosure.

FIG. 6 illustrates an example of a process that supports uplink downlink control information for scheduling multiple component carriers in accordance with aspects of the present disclosure.

FIG. 7 illustrates an example of a process that supports uplink downlink control information for scheduling multiple component carriers in accordance with aspects of the present disclosure.

FIGS. 8 and 9 show block diagrams of devices that support uplink downlink control information for scheduling multiple component carriers in accordance with aspects of the present disclosure.

FIG. 10 shows a block diagram of a communications manager that supports uplink downlink control information for scheduling multiple component carriers in accordance with aspects of the present disclosure.

FIG. 11 shows a diagram of a system including a device that supports uplink downlink control information for scheduling multiple component carriers in accordance with aspects of the present disclosure.

FIGS. 12 and 13 show block diagrams of devices that support uplink downlink control information for scheduling multiple component carriers in accordance with aspects of the present disclosure.

FIG. 14 shows a block diagram of a communications manager that supports uplink downlink control information for scheduling multiple component carriers in accordance with aspects of the present disclosure.

FIG. 15 shows a diagram of a system including a device that supports uplink downlink control information for scheduling multiple component carriers in accordance with aspects of the present disclosure.

FIGS. 16 through 21 show flowcharts illustrating methods that support uplink downlink control information for scheduling multiple component carriers in accordance with aspects of the present disclosure.

### DETAILED DESCRIPTION

Wireless communication systems may use a grant, such as a downlink control information (DCI) grant) to schedule uplink transmissions from a user equipment (UE) on a plurality of component carriers (CCs). For example, the wireless communications system may include a primary cell (PCell) that uses a dynamic spectrum sharing (DSS) carrier using 15 kHz sub-carrier spacing (SCS) while a secondary cell (SCell) uses a non-DSS carrier using 30 kHz SCS or 15 kHz (although the described techniques are not limited to these SCS combinations). The DCI grant may be transmitted from a carrier and schedule uplink transmissions from the UE on the DSS carrier of the PCell and schedule uplink transmissions from the UE on the non-DSS carrier of the SCell. However, improvements at the scheduling entity may be realized by transmitting the grant on a carrier that schedules uplink transmissions from the UE on the DSS carrier associated with the PCell as well as on the non-DSS carrier associated with the SCell. For example, this may be beneficial due to a single DCI being used for scheduling data on multiple carriers, rather than using multiple DCIs.

Aspects of the disclosure are initially described in the context of wireless communications systems. Generally, the described techniques provide various mechanisms that support uplink control information (UCI) being multiplexed on an uplink data transmission (e.g., uplink data communicated over a physical uplink shared channel (PUSCH)) on one or more CCs of a plurality of CCs. For example, a base station may identify or otherwise determine that UCI and the uplink data transmission are to be multiplexed on a first CC (e.g., CC1) or a second CC (e.g., CC2) of the multiple CCs. The base station may determine this for a UE. Accordingly, the base station may transmit or otherwise convey a DCI message to the UE that is for or otherwise associated with scheduling uplink transmissions from the UE (e.g., an uplink DCI scheduling PUSCH transmissions on multiple CCs). In some aspects, the DCI message may carry or otherwise convey an indication that a first uplink channel (e.g., a first PUSCH, or PUSCH1) on CC1 at least partially overlaps in the time domain with a second uplink channel (e.g., a second PUSCH, or PUSCH2) on CC2. This may indicate that UCI multiplexing is supported for the uplink transmissions. That is, the base station may implement a scheduling constraint such that PUSCH1 and PUSCH2 overlap at least some degree in the time domain. For example, PUSCH1 and PUSCH2 may completely overlap in the time domain or may partially overlap in the time domain. This scheduling constraint adopted by the base station may explicitly or implicitly indicate that the UE can multiplex UCI with the uplink data transmission on CC1 (e.g., PUSCH1) or with the uplink data transmission on CC2 (e.g., PUSCH2). Accordingly, the UE may receive the DCI and, based on the indication of the overlapping PUSCH transmissions, multiplex UCI with an uplink data transmission on CC1 or CC2. The UE may transmit the multiplexed UCI and uplink data transmission on the corresponding CC1 or CC2, e.g., the UCI multiplexed in PUSCH1 on CC1 or the UCI multiplexed on PUSCH2 on CC2.

Additionally or alternatively, aspects of the described techniques may support separate fields in the DCI message being used to identify that UCI multiplexing is supported on PUSCH1 on CC1 or on PUSCH2 CC2. For example, the base station may configure a first subset of fields associated with CC1 or a second subset of fields associated with CC2 of the DCI message to indicate multiplexing information for multiplexing UCI with an uplink data transmission on CC1 or with the uplink data transmission on CC2. Examples of the subsets of fields may include, but is not limited to, downlink assignment indicator (DAI) fields, beta offset fields, channel state information (CSI) fields, uplink scheduling indicator (UL-SCH) fields, and the like. The base station may transmit or otherwise convey the DCI message to the UE indicating that UCI multiplexing is supported for the uplink data transmissions on CC1 or CC2. The UE may determine whether and how UCI multiplexing is carried out for the PUSCH(s) scheduled by the DCI message. The UE may then transmit the multiplexed UCI/PUSCH on CC1 or CC2 to the base station.

Aspects of the disclosure are further illustrated by and described with reference to apparatus diagrams, system diagrams, and flowcharts that relate to uplink downlink control information for scheduling multiple component carriers.

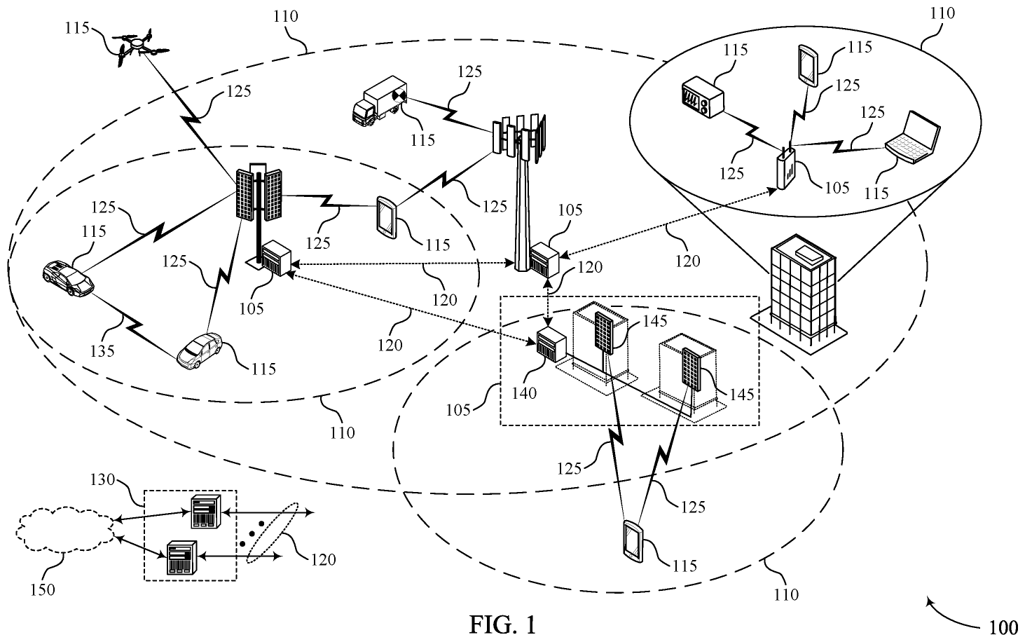

FIG. 1 illustrates an example of a wireless communications system 100 that supports uplink downlink control information for scheduling multiple component carriers in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may receive a DCI message associated with scheduling uplink transmissions from the UE 115 on a plurality of CCs. For example, the UE 115 may determine, based at least in part on the DCI message indicating that a first uplink channel on a first CC of the plurality of CCs at least partially overlaps in time with a second uplink channel on a second CC of the plurality of CCs, that UCI multiplexing is supported for the uplink transmissions. That is, the DCI message may indicate that a first uplink channel on a first CC of the set of CCs at least partially overlaps in time with a second uplink channel on a second CC of the set of CCs, and may indicate that UCI multiplexing is supported for the uplink transmissions. The UE 115 may multiplex, based on the first uplink channel at least partially overlapping in time with the second uplink channel, UCI with an uplink data transmission on the first CC or the second CC. The UE 115 may transmit the UCI and the uplink data transmission multiplexed on the first CC or the second CC based at least in part on the DCI message.

A UE 115 may receive a DCI message associated with scheduling uplink transmissions from the UE 115 on a plurality of CCs. For example, the UE 115 may determine, based at least in part on the DCI message indicating that a first uplink channel on a first CC of the plurality of CCs and a second uplink channel on a second CC of the plurality of CCs, that UCI multiplexing is supported for the uplink transmissions. That is, the DCI message indicate a first uplink channel on a first CC of the set of CCs and a second uplink channel on a second CC of the set of CCs. The UE 115 may multiplex, based at least in part on the first uplink channel at least partially overlapping in time with the second uplink channel, UCI with an uplink data transmission on the first CC according to a first subset of fields associated with the first CC in the DCI message or the UCI with the uplink data transmission on the second CC according to a second subset of fields associated with the second CC in the DCI message. The UE 115 may transmit the UCI and the uplink data transmission multiplexed on the first CC or the second CC based at least in part on the DCI message.

A base station 105 may determine, for a UE 115, that UCI and an uplink data transmission are to be multiplexed on a first CC or a second CC of a plurality of CCs. The base station 105 may transmit a DCI message associated with scheduling uplink transmissions from the UE 115 on the plurality of CCs, the DCI message indicating that a first uplink channel on the first CC of the plurality of CCs at least partially overlaps in time with a second uplink channel on the second CC of the plurality of CCs to indicate that UCI multiplexing is supported for the uplink data transmission. The base station 105 may receive the UCI and the uplink data transmission multiplexed on the first CC or the second CC based at least in part on the DCI message.

A base station 105 may configure a first subset of fields associated with a first CC in a DCI message or a second subset of fields associated with a second CC in the DCI message to indicate multiplexing information for multiplexing UCI with an uplink data transmission on the first CC or with the uplink data transmission on the second CC. The base station 105 may transmit, to a UE 115, the DCI message associated with scheduling uplink transmissions from the UE 115 on a plurality of CCs, the DCI message indicating that a first uplink channel on the first CC of the plurality of CCs and a second uplink channel on a second CC of the plurality of CCs are configured to indicate that UCI multiplexing is supported for the uplink transmissions. The base station 105 may receive the UCI and the uplink data transmission multiplexed on the first CC or the second CC based at least in part on the DCI message.

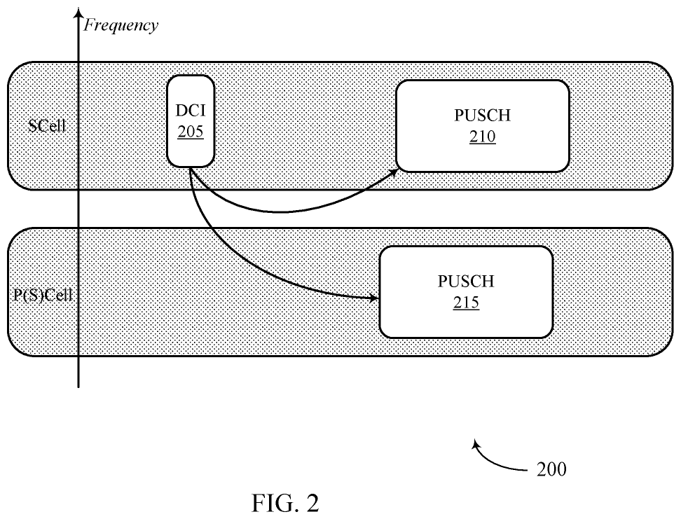

FIG. 2 illustrates an example of a CC configuration 200 that supports uplink DCI for scheduling multiple component carriers in accordance with aspects of the present disclosure. In some examples, CC configuration 200 may implement aspects of wireless communication system 100. Aspects of CC configuration 200 may be implemented by a base station (e.g., a PCell and/or SCell) and a UE, which may be examples of the corresponding devices described herein.

Wireless communication systems may use a grant, such as a DCI grant (e.g., DCI 205, which may be an example of a DCI message), to schedule transmissions from a UE on a plurality of CCs. For example, the wireless communications system may include a PCell that uses a first carrier (e.g., CC1) using 15 kHz SCS while a SCell uses a second carrier (CC2) using 30 kHz SCS or 15 kHz (although the described techniques are not limited to these SCS/CC combinations). In some examples, the DCI grant may be transmitted from a carrier associated with the PCell and schedule transmissions from the UE on the DSS carrier of the PCell (e.g., PUSCH 215) and schedule transmissions from the UE on the non-DSS carrier of the SCell (e.g., PUSCH 210). However, improvements at the scheduling entity may be realized by transmitting the grant on the non-DSS carrier of the SCell that schedules transmissions from the UE on the DSS carrier associated with the PCell as well as on the non-DSS carrier associated with the SCell. For example, this may be beneficial due to a single DCI being used for cross carrier scheduling, rather than using multiple DCIs.

In some aspects, DCI 205 may include a variety of fields associated with UCI multiplexing on PUSCH. For example, a DAI field may provide the information related to the number of HARQ-ACK bits multiplexed on a PUSCH. A CSI request field may indicate CSI-RS resource in the downlink for CSI measurement and the need for a CSI report carried by the scheduled PUSCH. A beta offset field may indicate or otherwise provide the information related to the ratio of coding rates between UL-SCH and UCI that are carried by the scheduled PUSCH. An UL-SCH field may indicate whether the PUSCH shall carry UL-SCH. A time domain resource allocation (TDRA) field may identify resources for a CC, e.g., time resources.

In some aspects, a PUSCH transmission (e.g., an uplink data transmission) scheduled by DCI 205 may contain UCI (e.g., HARQ-ACK, CSI, etc.). For a non-CA case, if the PUSCH is overlapping with a PUCCH for UCI (e.g., UCI that would typically be transmitted via PUCCH), the UCI may be piggybacked (e.g., multiplexed) on the PUSCH. For a CA case, if more than one PUSCHs are overlapping with a PUCCH for UCI, the UCI may be piggybacked on one or more PUSCHs. However, such piggybacking is implemented only if certain conditions are present, which severely limits UCI multiplexing.

However, aspects of the described techniques may support UCI multiplexing (e.g., piggybacking) with a PUSCH transmitted on CC1 or CC2. For example, a base station may identify or otherwise determine that UCI and the uplink data transmission are to be multiplexed on a first CC (e.g., CC1) or a second CC (e.g., CC2) of the multiple CCs. The base station may determine this for a UE. That is, for PUSCHs scheduled by the same DCI, TDRA may be restricted such that UCI multiplexing on PUSCH may be processed to either PUSCH. With this restriction (e.g., scheduling constraint), the various fields of DCI 205 discussed above may be used as described.

Accordingly, the base station may transmit or otherwise convey a DCI message to the UE that is for or otherwise associated with scheduling uplink transmissions from the UE (e.g., an uplink DCI scheduling PUSCH transmissions on multiple CCs, such as DCI 205 scheduling PUSCH 210 on CC1 and PUSCH 215 on CC2). In some aspects, the DCI message (e.g., DCI 205) may carry or otherwise convey an indication that a first uplink channel (e.g., PUSCH 210, or PUSCH1) on CC1 at least partially overlaps in the time domain with a second uplink channel (e.g., PUSCH 215, or PUSCH2) on CC2. This may indicate that UCI multiplexing is supported for the uplink transmissions. That is, the base station may implement a scheduling constraint such that PUSCH1 and PUSCH2 overlap at least some degree in the time domain. For example, PUSCH1 and PUSCH2 may completely overlap in the time domain (as is shown in FIG. 2) or may partially overlap in the time domain. This scheduling constraint adopted by the base station may explicitly or implicitly indicate that the UE can multiplex UCI with the uplink data transmission on CC1 (e.g., PUSCH1) or with the uplink data transmission on CC2 (e.g., PUSCH2). Accordingly, the UE may receive the DCI 205 and, based on the indication of the overlapping PUSCH transmissions, multiplex UCI with an uplink data transmission on CC1 or CC2. The UE may transmit the multiplexed UCI and uplink data transmission on the corresponding CCI or CC2, e.g., the UCI multiplexed in PUSCH1 on CC1 or the UCI multiplexed on PUSCH2 on CC2.

Accordingly, the UE may be configured with a single DCI (e.g., DCI 205) for multi-CC scheduling. The TDRA for PUSCHs in the multiple CCs may be either independent (e.g., a time resource allocation field for each CC) or joint (e.g., a single time resource allocation field for all CCs). In either case, the time domain resources that are indicated by the DCI may be overlapping each other so that the existing UCI multiplexing techniques discussed above may be adopted. That is, the scheduling constraint implemented at the base station may improve UCI multiplexing techniques.

In some aspects, the time overlapping PUSCHs may be based on the TDRA field indicated in DCI 205. In one example, the list of TDRA entries for PUSCH in the CCs may be restricted to ensure that the PUSCHs at least partially overlap. In another example, the list of TDRA entries for PUSCH in the CCs may not have such a restriction, but whenever DCI 205 schedules PUSCHs over two CCs, the combination of the indicated TDRA values may satisfy the restriction. In DCI 205 for multi-CC scheduling, the fields of the DCI 205 discussed above may provide the corresponding indications for one of the PUSCHs that will carry UCI.

Additionally or alternatively, aspects of the described techniques may support separate fields in the DCI message (e.g., DCI 205) being used to identify that UCI multiplexing is supported on PUSCH1 on CC1 (e.g., PUSCH 210) or on PUSCH2 CC2 (e.g., PUSCH 215). For example, the base station may configure a first subset of fields associated with CC1 or a second subset of fields associated with CC2 of the DCI message to indicate multiplexing information for multiplexing UCI with an uplink data transmission on CC1 or with the uplink data transmission on CC2. Examples of the subsets of fields may include, but is not limited to, DAI fields, beta offset fields, CSI fields, UL-SCH fields, and the like. The base station may transmit or otherwise convey the DCI message (e.g., DCI 205) to the UE indicating that UCI multiplexing is supported for the uplink data transmissions on CC1 or CC2. The UE may determine that UCI multiplexing is supported based on the DCI message and multiplex the UCI with the uplink data transmission on CC1 or on CC2. The UE may then transmit the multiplexed UCI/PUSCH on CC1 or CC2 to the base station. When there are two time-overlapping PUSCHs on CCI and CC2, which PUSCH to multiplex the UCI may be determined at least partially on the serving cell indexes of CC1 and CC2; UCI multiplexing is carried out on the PUSCH where the serving cell index is lower (or higher).

In some aspects, this approach supports flexible TDRA indications for PUSCHs on the CCs. The DCI 205 for multi-CC scheduling may have separate fields at least for DAI and beta-offset indicator for the UCI multiplexing indication. If the scheduled PUSCHs are overlapped as a consequence of TDRA indications, various aspects may be applied. In one aspects, this may include the same fields (DAI or beta-offset indicator) for CC1 and CC2 indicating the same value. In another aspects, the fields for one CC may be used as the DAI and beta-offset indicator, and the fields for the other CC may be ignored (e.g., left blank, filled with all “1s” or all “0s,” configured with an invalid indication, etc. In another aspects, the fields for one CC may be used as the DAI and beta-offset indicator, and the fields for the other CC may be fixed to be a particular values (e.g., all “1s”), so that these bits can be used as a virtual CRC. In another aspect, the fields for one CC may be used as the DAI and beta-offset indicator, and the fields for the other CC may be used as a complementary bit(s) for other field(s) (e.g., additional least significant bit (LSB) or most significant bit (MSB) bit(s) of the FDRA field).

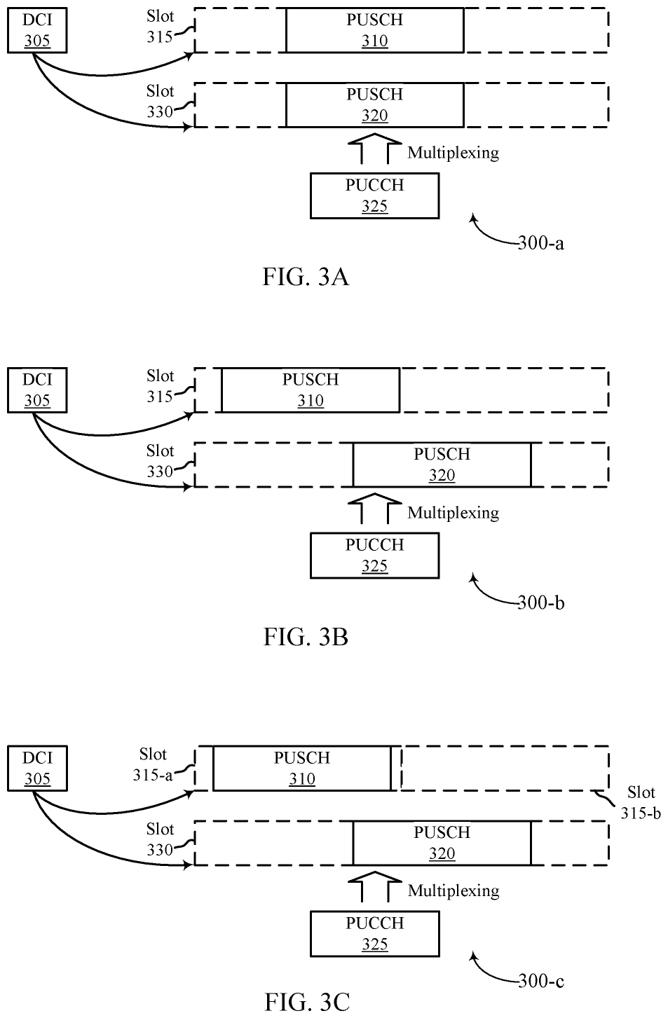

FIGS. 3A-3C illustrate examples of a CC configuration 300 that supports uplink DCI for scheduling multiple component carriers in accordance with aspects of the present disclosure. In some examples, CC configuration 300 may implement aspects of wireless communication system 100 and/or CC configuration 200. Aspects of CC configuration 300 may be implemented by a base station (e.g., a PCell and/or SCell) and a UE, which may be examples of the corresponding devices described herein.

As discussed above, aspects of the described techniques may support UCI multiplexing (e.g., piggybacking) with a PUSCH transmitted on CC1 or CC2. For example, a base station may identify or otherwise determine that UCI (e.g., PUCCH 325) and the uplink data transmission are to be multiplexed on a first CC (e.g., PUSCH 310 on CC1) or a second CC (e.g., PUSCH 320 on CC2) of the multiple CCs. The base station may determine this for a UE. Accordingly, the base station may transmit or otherwise convey a DCI message (e.g., DCI 305) to the UE that is for or otherwise associated with scheduling uplink transmissions from the UE (e.g., an uplink DCI scheduling PUSCH transmissions on multiple CCs, such as DCI 305 scheduling PUSCH 310 on CC1 and PUSCH 320 on CC2). In some aspects, the DCI message (e.g., DCI 305) may carry or otherwise convey an indication that a first uplink channel (e.g., PUSCH 310, or PUSCH1) on CC1 at least partially overlaps in the time domain with a second uplink channel (e.g., PUSCH 320, or PUSCH2) on CC2. This may indicate that UCI multiplexing is supported for the uplink transmissions. That is, the base station may implement a scheduling constraint such that PUSCH1 and PUSCH2 overlap at least some degree in the time domain. This scheduling constraint adopted by the base station may explicitly or implicitly indicate that the UE can multiplex UCI with the uplink data transmission on CC1 (e.g., PUSCH1) or with the uplink data transmission on CC2 (e.g., PUSCH2). Accordingly, the UE may receive the DCI 305 and, based on the indication of the overlapping PUSCH transmissions, multiplex UCI with an uplink data transmission on CC1 or CC2. The UE may transmit the multiplexed UCI and uplink data transmission on the corresponding CC1 or CC2, e.g., the UCI multiplexed in PUSCH1 on CC1 or the UCI multiplexed on PUSCH2 on CC2.

Additionally or alternatively, aspects of the described techniques may support separate fields in the DCI message (e.g., DCI 305) being used to identify that UCI multiplexing is supported on PUSCH1 on CC1 (e.g., PUSCH 310) or on PUSCH2 CC2 (e.g., PUSCH 320). For example, the base station may configure a first subset of fields associated with CC1 or a second subset of fields associated with CC2 of the DCI message to indicate multiplexing information for multiplexing UCI with an uplink data transmission on CC1 or with the uplink data transmission on CC2. Examples of the subsets of fields may include, but is not limited to, DAI fields, beta offset fields, CSI fields, UL-SCH fields, and the like. The base station may transmit or otherwise convey the DCI message (e.g., DCI 305) to the UE indicating that UCI multiplexing is supported for the uplink data transmissions on CC1 or CC2. The UE may determine that UCI multiplexing is supported based on the DCI message and multiplex the UCI with the uplink data transmission on CC1 or on CC2. The UE may then transmit the multiplexed UCI/PUSCH on CC1 or CC2 to the base station. In some examples of this technique, the separate TDRA fields or joint TDRA field may also be configured such that the uplink data transmission on CC1 at least partially overlaps with the uplink data transmission on CC2.

CC configuration 300 illustrated in FIGS. 3A-3C illustrate three examples of how such PUSCH transmissions may overlap in time in accordance with aspects of the described techniques. With reference to CC configuration 300-a of FIG. 3A, DCI 305 may schedule PUSCH 310 on CC1 during slot 315 and PUSCH 320 on CC2 during slot 330. PUSCH 310 fully overlaps with respect to PUSCH 320 in the time domain, e.g., using the scheduling constraint and/or the separate fields approach discussed above. That is, PUSCH 310 and PUSCH 320 share the same start time, end time, duration, etc. Accordingly, the UE may multiplex UCI (e.g., PUCCH 325) onto at least one of the PUSCH transmissions (with PUCCH 325 being shown as multiplexed onto PUSCH 320 of CC2 by way of example only).

Referring now to CC configuration 300-b of FIG. 3B, DCI 305 may schedule PUSCH 310 on CCI during slot 315 and PUSCH 320 on CC2 during slot 330. PUSCH 310 partially overlaps with respect to PUSCH 320 in the time domain, e.g., using the scheduling constraint and/or the separate fields approach discussed above. That is, PUSCH 310 starts before PUSCH 320, but PUSCH 320 starts before the end time of PUSCH 310. Thus, for at least some period in the time domain, PUSCH 310 partially overlaps with PUSCH 320. Accordingly, the UE may multiplex UCI (e.g., PUCCH 325) onto at least one of the PUSCH transmissions (with PUCCH 325 being shown as multiplexed onto PUSCH 320 of CC2 by way of example only).

Referring now to CC configuration 300-c of FIG. 3C, DCI 305 may schedule PUSCH 310 on CCI during slot 315-a and PUSCH 320 on CC2 during slot 330. PUSCH 310 partially overlaps with respect to PUSCH 320 in the time domain, e.g., using the scheduling constraint and/or the separate fields approach discussed above. That is, PUSCH 310 starts before PUSCH 320, but PUSCH 320 starts before the end time of PUSCH 310. Thus, for at least some period in the time domain, PUSCH 310 partially overlaps with PUSCH 320. Accordingly, the UE may multiplex UCI (e.g., PUCCH 325) onto at least one of the PUSCH transmissions (with PUCCH 325 being shown as multiplexed onto PUSCH 320 of CC2 by way of example only).

In some aspects of either approach discussed above, the uplink data transmissions may be transmitted during respective slots. However, it is to be understood that, in some examples, the different CCs may be associated with different SCS configurations. Accordingly, the slot durations for one CC may be different than the slot durations for the other CC. As illustrated in CC configuration 300-c of FIG. 3C, the slot duration of CC1 is shorter than the slot duration of CC2, e.g., due to different SCS configurations for each CC. In this illustrated example, the slot duration of CC1 is half the duration in the time domain than the slot duration of CC2. Accordingly, the slot duration of slot 330 encompasses two slot durations of slot 315 (e.g., slots 315-a and 315-b). However, it is also to be understood that the scheduled PUSCH transmissions on each respective CC may still be configured to, or otherwise, overlap in the time domain. In the example illustrated in CC configuration 300-c, PUSCH 320 spans, at least to some degree, both of slots 315-a and 315-b.

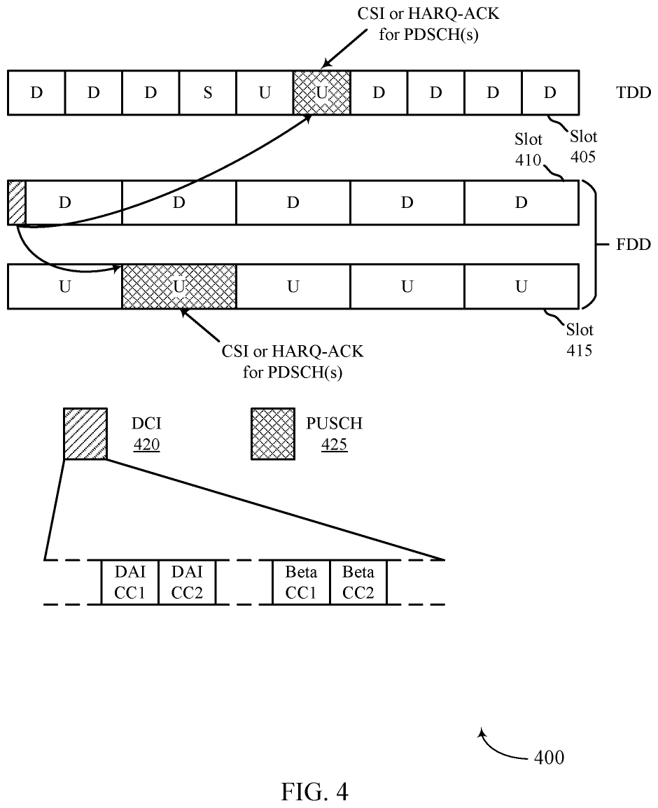

FIG. 4 illustrates an example of a CC configuration 400 that supports uplink DCI for scheduling multiple component carriers in accordance with aspects of the present disclosure. In some examples, CC configuration 400 may implement aspects of wireless communication system 100 and/or CC configurations 200 and/or 300. Aspects of CC configuration 400 may be implemented by a base station (e.g., a PCell and/or SCell) and a UE, which may be examples of the corresponding devices described herein.

As discussed above, aspects of the described techniques may support UCI multiplexing (e.g., piggybacking) with a PUSCH transmitted on CC1 or CC2. For example, aspects of the described techniques may support separate fields in the DCI message (e.g., DCI 420) being used to identify that UCI multiplexing is supported on PUSCH1 on CC1 (e.g., PUSCH 425 on CC1) or on PUSCH2 CC2 (e.g., PUSCH 425 on CC2). For example, the base station may configure a first subset of fields (e.g., DAI and beta offset for CC1) associated with CC1 or a second subset of fields (e.g., DAI and beta offset for CC2) associated with CC2 of the DCI message (e.g., DCI 420) to indicate multiplexing information for multiplexing UCI with an uplink data transmission on CCI or with the uplink data transmission on CC2. Examples of the subsets of fields may include, but are not limited to, DAI fields, beta offset fields, CSI fields, UL-SCH fields, and the like. The base station may transmit or otherwise convey the DCI message (e.g., DCI 420) to the UE indicating that UCI multiplexing is supported for the uplink data transmissions on CC1 or CC2. The UE may determine that UCI multiplexing is supported based on the DCI message and multiplex the UCI with the uplink data transmission on CC1 or on CC2. The UE may then transmit the multiplexed UCI/PUSCH on CC1 or CC2 to the base station. In some examples of this technique, separate TDRA fields or joint TDRA field may also be configured such that the uplink data transmission on CCI at least partially overlaps with the uplink data transmission on CC2.

In some aspects, this technique may be implemented for FDD-TDD CA. For example, in TDD one CC (e.g., CC1 in this example) may support both uplink and downlink communications during a slot 405. For example, a slot format indicator (SFI) may indicate whether a slot 405 is for uplink (U) communications or for downlink (D) communications. For FDD CA, one CC may be used for downlink communications during a slot 410 and another CC (e.g., CC2 in this example) may be used for uplink communications during a slot 415. As also discussed above, in some examples CC1 and CC2 may be associated with different SCS such that the slot durations are different. In the non-limiting example illustrated in FIG. 4, the CC1 (the TDD carrier) may have a slot duration for slot 405 that is different from the slot duration for slot 415 on CC2 (the FDD U carrier).

Accordingly, in this example the DCI message may be communicated on a carrier that is different from CC1 and CC2. For example, the DCI message (e.g., DCI 420) may be transmitted to the UE on the FDD D carrier during a slot 410. The DCI message may indicate that UCI multiplexing is support for an uplink data transmission scheduled on CC1 during a slot 405 configured for uplink communications or for an uplink data transmission scheduled on CC2 during a slot 415. As illustrated in CC configuration 400, the uplink data transmissions (e.g., PUSCH 425) do not overlap in the time domain. Accordingly, the combination of the first subset of fields (e.g., separate or joint TDRA, DAI, beta offset fields) of DCI 420 may identify the slot 405 of the TDD carrier (e.g., CC1) that PUSCH 425 may be transmitted. Similarly, the combination of the second subset of fields (e.g., separate or joint TDRA, DAI, beta offset fields) of DCI 420 may identify the slot 415 of the FDD U carrier (e.g., CC2) that PUSCH 425 may be transmitted. The UE may receive DCI 420, recover the appropriate fields, and multiplex UCI (e.g., HARQ-ACK, CSI, etc.) onto the indicated PUSCH 425 transmission.

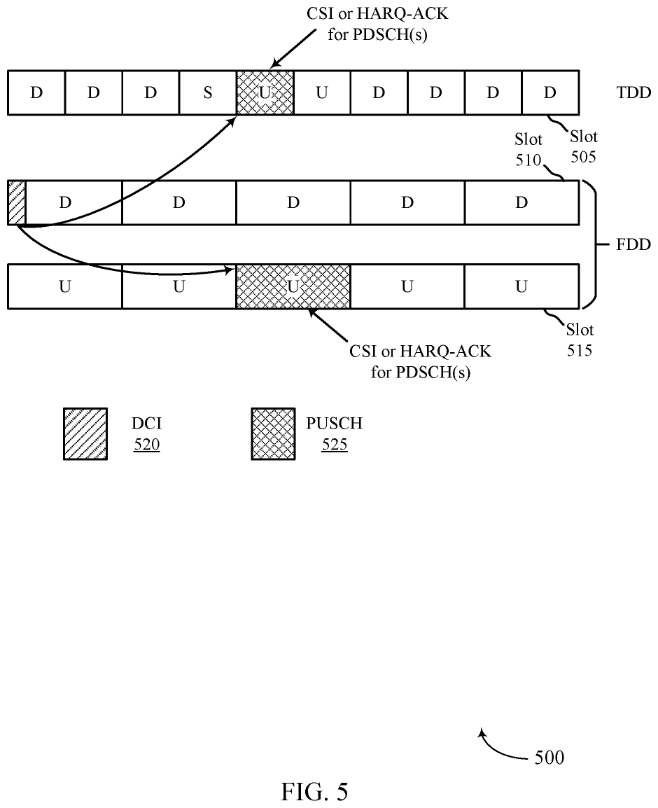

FIG. 5 illustrates an example of a CC configuration 500 that supports uplink DCI for scheduling multiple CCs in accordance with aspects of the present disclosure. In some examples, CC configuration 500 may implement aspects of wireless communication system 100 and/or CC configurations 200, 300 and/or 400. Aspects of CC configuration 500 may be implemented by a base station (e.g., a PCell and/or SCell) and a UE, which may be examples of the corresponding devices described herein.

As discussed above, aspects of the described techniques may support UCI multiplexing (e.g., piggybacking) with a PUSCH transmitted on CC1 or CC2. For example, a base station may identify or otherwise determine that UCI (e.g., of a PUCCH) and the uplink data transmission are to be multiplexed on a first CC (e.g., PUSCH 525 on CC1, which is the TDD carrier in this example) or a second CC (e.g., PUSCH 525 on CC2, which is the FDD U carrier in this example) of the multiple CCs. The base station may determine this for a UE. Accordingly, the base station may transmit or otherwise convey a DCI message (e.g., DCI 520) to the UE that is for or otherwise associated with scheduling uplink transmissions from the UE (e.g., an uplink DCI scheduling PUSCH transmissions on multiple CCs, such as DCI 520 scheduling PUSCH 525 on CC1 or CC2). In some aspects, the DCI message (e.g., DCI 520) may carry or otherwise convey an indication that a first uplink channel (e.g., PUSCH 525 on CC1) at least partially overlaps in the time domain with a second uplink channel (e.g., PUSCH 525 on CC2). This may indicate that UCI multiplexing is supported for the uplink transmissions. That is, the base station may implement a scheduling constraint such that PUSCH1 and PUSCH2 overlap at least some degree in the time domain. This scheduling constraint adopted by the base station may explicitly or implicitly indicate that the UE can multiplex UCI (e.g., HARQ-ACK, CSI, etc.) with the uplink data transmission on CC1 (e.g., PUSCH1) or with the uplink data transmission on CC2 (e.g., PUSCH2). Accordingly, the UE may receive the DCI 420 and, based on the indication of the overlapping PUSCH transmissions, multiplex UCI with an uplink data transmission on CC1 or CC2. The UE may transmit the multiplexed UCI and uplink data transmission on the corresponding CC1 or CC2, e.g., the UCI multiplexed in PUSCH1 on CC1 or the UCI multiplexed on PUSCH2 on CC2.

Additionally or alternatively, aspects of the described techniques may support UCI multiplexing (e.g., piggybacking) with a PUSCH transmitted on CC1 or CC2. For example, aspects of the described techniques may support separate fields in the DCI message (e.g., DCI 520) being used to identify that UCI multiplexing is supported on PUSCH1 on CC1 (e.g., PUSCH 525 on CC1) or on PUSCH2 CC2 (e.g., PUSCH 525 on CC2). For example, the base station may configure a first subset of fields (e.g., DAI and beta offset for CC1) associated with CCI or a second subset of fields (e.g., DAI and beta offset for CC2) associated with CC2 of the DCI message (e.g., DCI 520) to indicate multiplexing information for multiplexing UCI with an uplink data transmission on CC1 or with the uplink data transmission on CC2. Examples of the subsets of fields may include, but are not limited to, DAI fields, beta offset fields, CSI fields, UL-SCH fields, and the like. The base station may transmit or otherwise convey the DCI message (e.g., DCI 520) to the UE indicating that UCI multiplexing is supported for the uplink data transmissions on CC1 or CC2. The UE may determine that UCI multiplexing is supported based on the DCI message and multiplex the UCI with the uplink data transmission on CC1 or on CC2. The UE may then transmit the multiplexed UCI/PUSCH on CC1 or CC2 to the base station. In some examples of this technique, separate TDRA fields or a joint TDRA field may also be configured such that the uplink data transmission on CC1 at least partially overlaps with the uplink data transmission on CC2.

In some aspects, this technique may be implemented for FDD-TDD CA. For example, in TDD one CC (e.g., CC1 in this example) may support both uplink and downlink communications during a slot 505. For example, a SFI may indicate whether a slot 505 is for uplink (U) communications or for downlink (D) communications. For FDD CA, one CC may be used for downlink communications during a slot 510 and another CC (e.g., CC2 in this example) may be used for uplink communications during a slot 515. As also discussed above, in some examples CC1 and CC2 may be associated with different SCS such that the slot durations are different. In the non-limiting example illustrated in FIG. 5, the CC1 (the TDD carrier) may have a slot duration for slot 505 that is different from the slot duration for slot 515 on CC2 (the FDD U carrier).

Accordingly, in this example the DCI message may be communicated on a carrier that is different from CC1 and CC2. For example, the DCI message (e.g., DCI 520) may be transmitted to the UE on the FDD D carrier during a slot 510. The DCI message may indicate that UCI multiplexing is support for an uplink data transmission scheduled on CC1 during a slot 505 configured for uplink communications or for an uplink data transmission scheduled on CC2 during a slot 515. As illustrated in CC configuration 400, the uplink data transmissions (e.g., PUSCH 525) overlap in the time domain. The at least partial overlap in the time domain between PUSCH 525 on CC1 and PUSCH 525 on CC2 may be implemented based on the scheduling constraint and/or based on separate fields of DCI 520 discussed above.

Accordingly, the combination of the first subset of fields (e.g., separate or joint TDRA, DAI, beta offset fields) of DCI 520 may identify the slot 505 of the TDD carrier (e.g., CC1) that PUSCH 525 may be transmitted. Similarly, the combination of the second subset of fields (e.g., separate or joint TDRA, DAI, beta offset fields) of DCI 520 may identify the slot 515 of the FDD U carrier (e.g., CC2) that PUSCH 525 may be transmitted. In some aspects, the TDRA fields may indicate the timing component of scheduling PUSCH 525 on CC1 or CC2 in a manner where such PUSCH transmissions at least partially overlap. The UE may receive DCI 520, recover the appropriate fields, and multiplex UCI (e.g., HARQ-ACK, CSI, etc.) onto the indicated PUSCH 525 transmission.

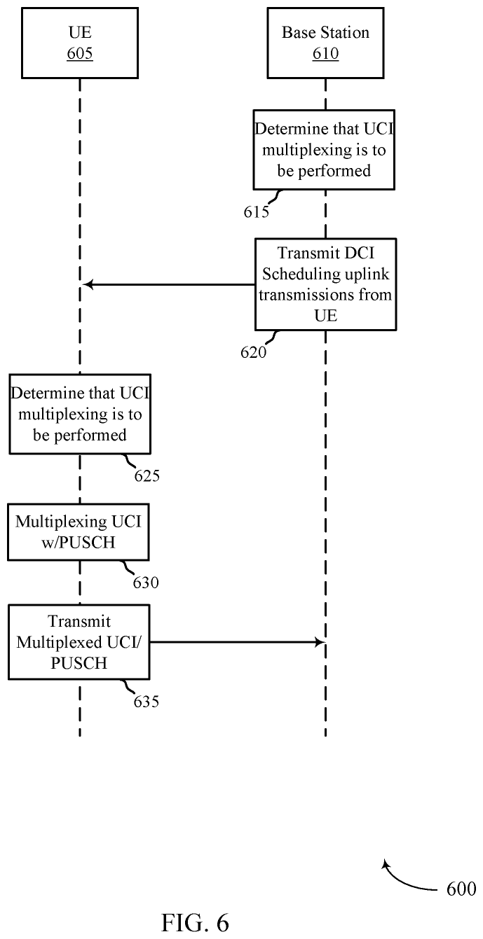

FIG. 6 illustrates an example of a process 600 that supports uplink DCI for scheduling multiple CCs in accordance with aspects of the present disclosure. In some examples, process 600 may implement aspects of wireless communication system 100 and/or CC configurations 200, 300, 400, and/or 500. Aspects of process 600 may be implemented by UE 605 and/or base station 610, which may be examples of corresponding devices described herein.

At 615, base station 610 may identify or otherwise determine, for UE 605, that UCI and an uplink data transmission (e.g., PUSCH) are to be multiplexed on a first CC or a second CC of a plurality of CCs.

At 620, base station 610 may transmit (and UE 605 may receive) a DCI message associated with scheduling uplink transmissions from UE 605 on the plurality of CCs. In some aspects, the DCI message may carry or otherwise convey an indication that a first uplink channel (e.g., PUSCH1) on the first CC at least partially overlaps in the time domain with a second uplink channel (e.g., PUSCH2). In some aspects, the indication of the time overlap may implicitly and/or explicitly indicate that UCI multiplexing is supported for the uplink data transmission.

In some aspects, this may include base station 610 configuring a TDRA field (e.g., a joint TDRA field) of the DCI message to carry or otherwise convey an indication that the first uplink channel on CC1 at least partially overlaps in time with the second uplink channel on CC2. For example, base station 610 may configure a first TDRA entry indicated in a first TDRA field of the DCI message and configure a second TDRA entry in a second TDRA field (e.g., separate TDRA fields). The first TDRA entry and the second TDRA entry may schedule the overlapping uplink transmissions.

In some aspects, this may include base station 610 configuring a subset of fields in the DCI message to carry or otherwise convey an indication of information associated with multiplexing the UCI with the uplink data transmission on CC1 or CC2. For example, base station 610 may configure a DAI field, beta offset field, CSI request field, an uplink scheduling indicator field, and the like, with information identifying which CC that the UCI is to be multiplexed with.

At 625, UE 605 may determine that UCI multiplexing is supported for the uplink transmission based on the DCI message. For example, UE 605 may decode or otherwise recover a joint or separate TDRA field from the DCI message scheduling the overlapping uplink transmissions.

In some aspects, this may include UE 605 determining that the DCI message indicates that the first uplink channel on CC1 at least partially overlaps in time with the second uplink channel on CC2 based on a joint or separate TDRA fields of the DCI message. For example, UE 605 may identify a first TDRA entry in a first TDRA field of the DCI message and a second TDRA entry in a second TDRA field of the DCI message to determine that UCI multiplexing is supported for overlapping PUSCH transmissions.

At 630, UE 605 may multiplex UCI with an uplink data transmission on the first CC or the second CC. For example, UE 605 may multiplex UCI with an uplink data transmission scheduled on CC1 that overlaps with an uplink data transmissions scheduled on CC2. In another example, UE 605 may multiplex UCI with an uplink data transmissions scheduled on CC2 that overlaps with an uplink data transmissions scheduled on CC1. In some aspects, one or more fields of the DCI message may indicate which CC that UCI multiplexing is to be performed on.

In some aspects, this may include UE 605 multiplexing the UCI with the uplink data transmission on CC1 or CC2 based on a subset of fields indicated in the DCI message. For example, UE 605 may decode or otherwise recover information from the DAI field, beta offset field, CSI request field, etc., of the DCI message to identify which CC that UCI is to be multiplexed on.

At 635, UE 605 may transmit (and base station 610 may receive) the UCI and the uplink data transmission multiplexed on the first CC or the second CC. For example, UE 605 may transmit UCI multiplexed with PUSCH on CC1 or multiplexed with PUSCH on CC2.

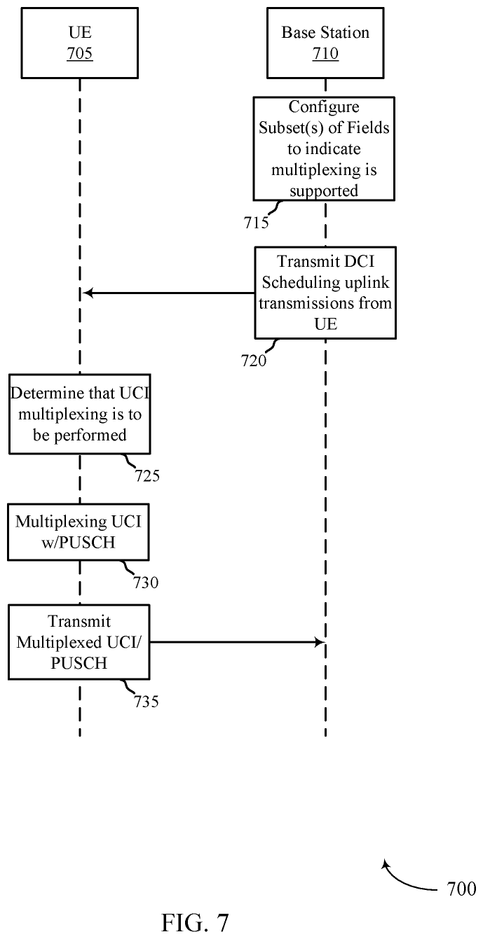

FIG. 7 illustrates an example of a process 700 that supports uplink DCI for scheduling multiple CCs in accordance with aspects of the present disclosure. In some examples, process 700 may implement aspects of wireless communication system 100 and/or CC configurations 200, 300, 400, and/or 500. Aspects of process 700 may be implemented by UE 705 and/or base station 710, which may be examples of corresponding devices described herein.

At 715, base station 710 may configure a first subset of fields associated with CC1 in the DCI message or a second subset of fields associated with CC2 in the DCI message to carry or otherwise convey an indication of multiplexing information for multiplexing UCI with an uplink data transmission on CC1 or with an uplink data transmission on CC2. Examples of fields in the first subset of fields and/or second subset of fields include, but are not limited to, DAI fields, beta offset fields, TDRA fields, and the like.

In some aspects, this may include base station 710 configuring the DCI message to carry or otherwise convey an indication that the first uplink channel on CC1 at least partially overlaps in the time domain with the second uplink channel on CC2 (e.g., fully overlaps or partially overlaps). For example, the first subset of fields associated with CC1 and the second subset of fields associated with CC2 may indicate the same information or set of values.

At 720, base station 710 may transmit (and UE 705 may receive) the DCI message associated with scheduling uplink transmissions from UE 705. As discussed, the DCI message may indicate that a first uplink channel on CC1 and a second uplink channel and CC2 are configured to indicate that UCI multiplexing is supported for the uplink transmissions.

At 725, UE 705 may determine (e.g., based on the DCI message) that UCI multiplexing is supported for the uplink transmissions. For example, UE 705 may decode or otherwise recover information from the first subset of fields and the second subset of fields of the DCI message to determine that UCI multiplexing is supported.

Accordingly and at 730, UE 705 may multiplex UCI with an uplink data transmission on CC1 according to a first subset of fields associated with CC1 in the DCI message or with uplink data transmission on CC2 according to a second subset of fields associated with CC2 in the DCI message.

In some aspects, this may include UE 705 using the first subset of fields to multiplex the UCI and the uplink data transmission on CC1, where the second subset of fields associated with CC2 indicates a fixed set of values or being used as complementary bits (e.g., bits in the second subset of fields being used to add to the bitmap indicated in the first subset of fields). In some aspects, this may include UE 705 using the second subset of fields to multiplex the UCI and the uplink data transmission on CC2, where the first subset of fields associated with CC1 indicate a fixed set of values or being used as complementary bits.

At 735, UE 705 may transmit (and base station 710 may receive) the UCI and the uplink data transmission multiplexed on CC1 or CC2. For example, UE 705 may transmit UCI multiplexed with PUSCH on CC1 or multiplexed with PUSCH on CC2.

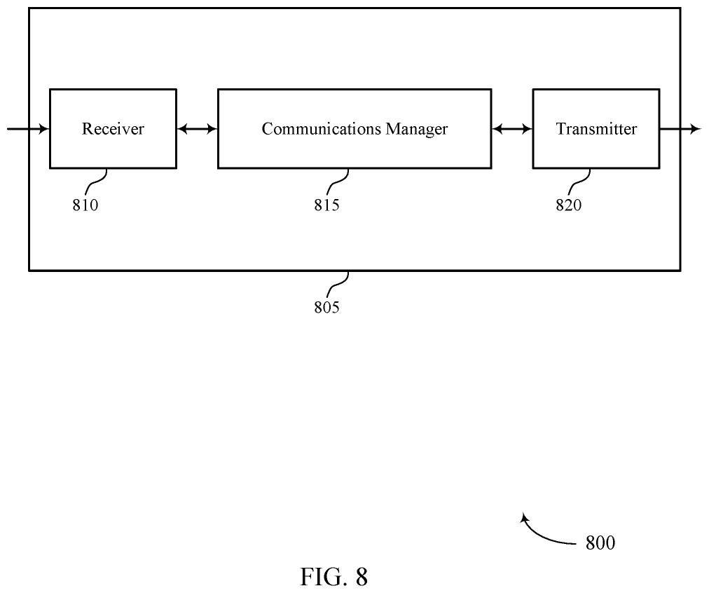

FIG. 8 shows a block diagram 800 of a device 805 that supports uplink DCI for scheduling multiple CCs in accordance with aspects of the present disclosure. The device 805 may be an example of aspects of a UE 115 as described herein. The device 805 may include a receiver 810, a communications manager 815, and a transmitter 820. The device 805 may also include a processor. Each of these components may be in communication with one another (e.g., via one or more buses).

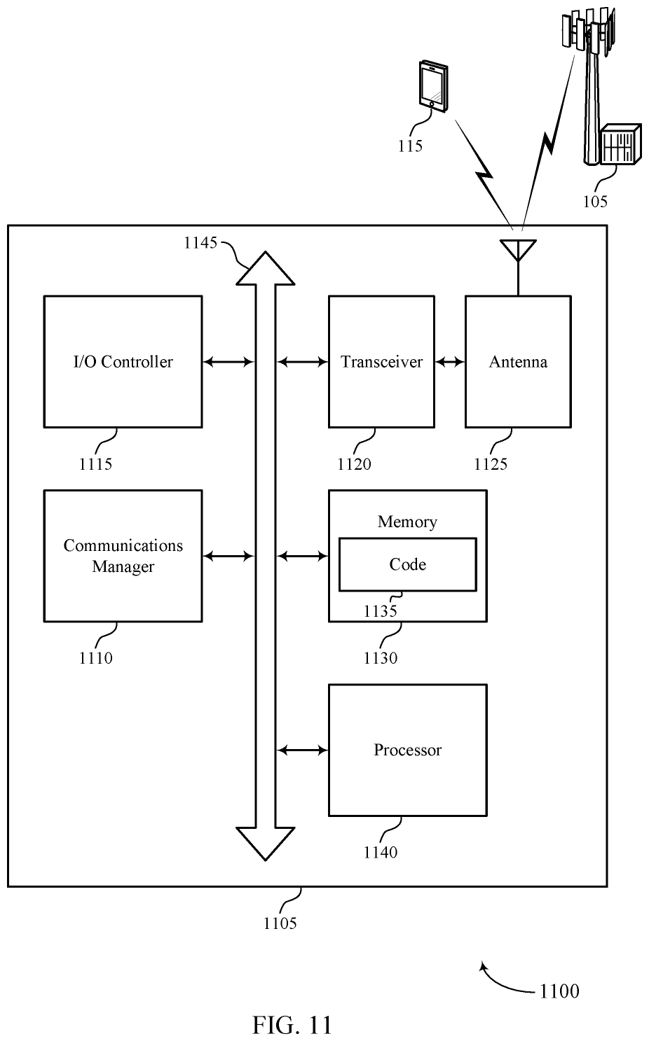

The receiver 810 may receive information such as packets, user data, or control information associated with various information channels (e.g., control channels, data channels, and information related to uplink DCI for scheduling multiple CCs, etc.). Information may be passed on to other components of the device 805. The receiver 810 may be an example of aspects of the transceiver 1120 described with reference to FIG. 11. The receiver 810 may utilize a single antenna or a set of antennas.

The communications manager 815 may receive a DCI message associated with scheduling uplink transmissions from the UE on a set of CCs, the DCI message indicating that a first uplink channel on a first CC of the set of CCs at least partially overlaps in time with a second uplink channel on a second CC of the set of CCs, multiplex, based on the first uplink channel at least partially overlapping in time with the second uplink channel, UCI with an uplink data transmission on the first CC or the second CC, and transmit the UCI and the uplink data transmission multiplexed on the first CC or the second CC based at least in part on the DCI message.

The communications manager 815 may also receive a DCI message associated with scheduling uplink transmissions from the UE on a set of CCs, the DCI message indicating a first uplink channel on a first CC of the set of CCs and a second uplink channel on a second CC of the set of CCs, multiplex, based at least in part on the first uplink channel at least partially overlapping in time with the second uplink channel, UCI with an uplink data transmission on the first CC according to a first subset of fields associated with the first CC in the DCI message or the UCI with the uplink data transmission on the second CC according to a second subset of fields associated with the second CC in the DCI message, and transmit the UCI and the uplink data transmission multiplexed on the first CC or the second CC based at least in part on the DCI message. The communications manager 815 may be an example of aspects of the communications manager 1110 described herein.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

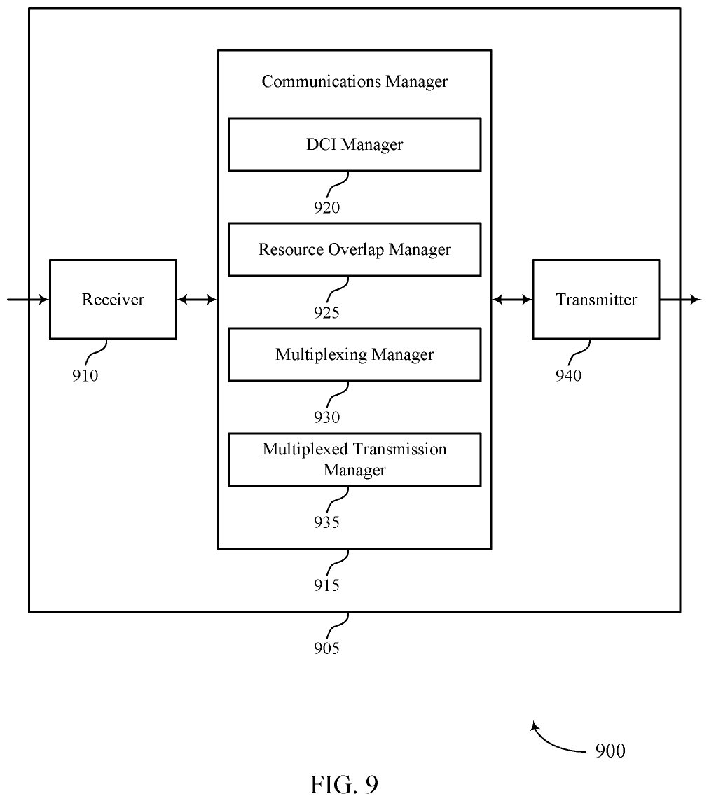

FIG. 9 shows a block diagram 900 of a device 905 that supports uplink DCI for scheduling multiple CCs in accordance with aspects of the present disclosure. The device 905 may be an example of aspects of a device 805, or a UE 115 as described herein. The device 905 may include a receiver 910, a communications manager 915, and a transmitter 940. The device 905 may also include a processor. Each of these components may be in communication with one another (e.g., via one or more buses).

The receiver 910 may receive information such as packets, user data, or control information associated with various information channels (e.g., control channels, data channels, and information related to uplink DCI for scheduling multiple CCs, etc.). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a DCI manager 920, a resource overlap manager 925, a multiplexing manager 930, and a multiplexed transmission manager 935. The communications manager 915 may be an example of aspects of the communications manager 1110 described herein.

The DCI manager 920 may receive a DCI message associated with scheduling uplink transmissions from the UE on a set of CCs. The DCI message may indicate that a first uplink channel on a first CC of the set of CCs at least partially overlaps in time with a second uplink channel on a second CC of the set of CCs.

The resource overlap manager 925 may determine, based on the DCI message indicating that a first uplink channel on a first CC of the set of CCs at least partially overlaps in time with a second uplink channel on a second CC of the set of CCs, that UCI multiplexing is supported for the uplink transmissions.

The multiplexing manager 930 may multiplex, based on the first uplink channel at least partially overlapping in time with the second uplink channel, UCI with an uplink data transmission on the first CC or the second CC.

The multiplexed transmission manager 935 may transmit the UCI and the uplink data transmission multiplexed on the first CC or the second CC based at least in part on the DCI message.

The DCI manager 920 may receive a DCI message associated with scheduling uplink transmissions from the UE on a set of CCs. The DCI message may indicate a first uplink channel on a first CC of the set of CCs and a second uplink channel on a second CC of the set of CCs.

The multiplexing manager 930 may multiplex, based at least in part on the first uplink channel at least partially overlapping in time with the second uplink channel, UCI with an uplink data transmission on the first CC according to a first subset of fields associated with the first CC in the DCI message or the UCI with the uplink data transmission on the second CC according to a second subset of fields associated with the second CC in the DCI message.

The multiplexed transmission manager 935 may transmit the UCI and the uplink data transmission multiplexed on the first CC or the second CC based at least in part on the DCI message.

The transmitter 940 may transmit signals generated by other components of the device 905. In some examples, the transmitter 940 may be collocated with a receiver 910 in a transceiver module. For example, the transmitter 940 may be an example of aspects of the transceiver 1120 described with reference to FIG. 11. The transmitter 940 may utilize a single antenna or a set of antennas.

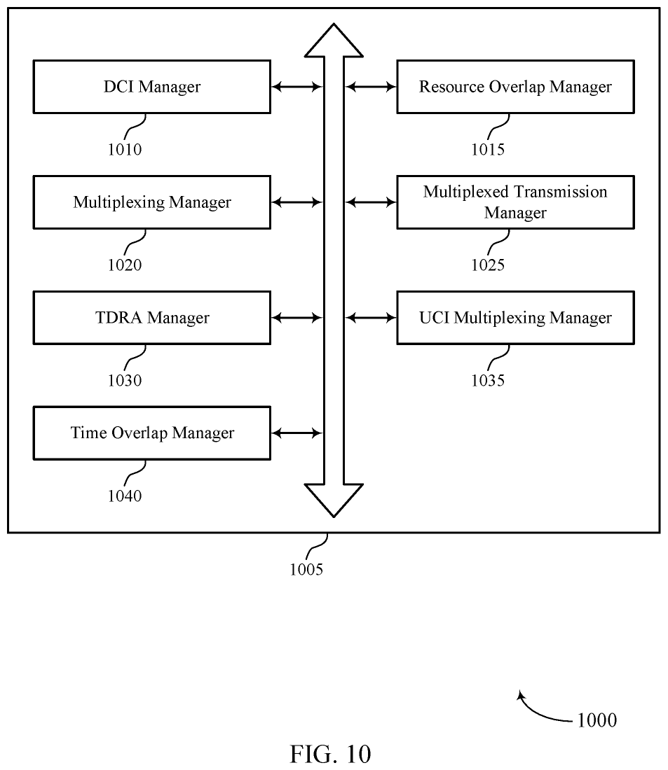

FIG. 10 shows a block diagram 1000 of a communications manager 1005 that supports uplink DCI for scheduling multiple CCs in accordance with aspects of the present disclosure. The communications manager 1005 may be an example of aspects of a communications manager 815, a communications manager 915, or a communications manager 1110 described herein. The communications manager 1005 may include a DCI manager 1010, a resource overlap manager 1015, a multiplexing manager 1020, a multiplexed transmission manager 1025, a TDRA manager 1030, an UCI multiplexing manager 1035, and a time overlap manager 1040. Each of these modules may communicate, directly or indirectly, with one another (e.g., via one or more buses).

The DCI manager 1010 may receive a DCI message associated with scheduling uplink transmissions from the UE on a set of CCs. In some examples, the DCI manager 1010 may receive a DCI message associated with scheduling uplink transmissions from the UE on a set of CCs.

The resource overlap manager 1015 may determine, based on the DCI message indicating that a first uplink channel on a first CC of the set of CCs at least partially overlaps in time with a second uplink channel on a second CC of the set of CCs, that UCI multiplexing is supported for the uplink transmissions.

The multiplexing manager 1020 may multiplex, based on the determining, UCI with an uplink data transmission on the first CC or the second CC.

In some examples, the multiplexing manager 1020 may determine, based on the DCI message indicating that a first uplink channel on a first CC of the set of CCs and a second uplink channel on a second CC of the set of CCs, that UCI multiplexing is supported for the uplink transmissions.

In some examples, the multiplexing manager 1020 may multiplex, based on the determining, UCI with an uplink data transmission on the first CC according to a first subset of fields associated with the first CC in the DCI message or with the uplink data transmission on the second CC according to a second subset of fields associated with the second CC in the DCI message.

In some cases, the UCI includes acknowledgment feedback information, or channel state information, or a scheduling request, or a combination thereof. In some cases, the first subset of fields include a first downlink assignment indicator field and a first beta offset field associated with the first CC. In some cases, the second subset of fields include a second downlink assignment indicator field and a second beta offset field associated with the second CC. In some cases, the first CC is configured as a time division duplexing carrier. In some cases, the second CC is configured as a frequency division duplexing carrier.

The multiplexed transmission manager 1025 may transmit the UCI and the uplink data transmission multiplexed on the first CC or the second CC. In some examples, the multiplexed transmission manager 1025 may transmit the UCI and the uplink data transmission multiplexed on the first CC or the second CC.

The TDRA manager 1030 may determine that the DCI message indicates that the first uplink channel on the first CC at least partially overlaps in time with the second uplink channel on the second CC based on one or more TDRA fields of the DCI message. In some examples, the TDRA manager 1030 may identify, based on the DCI message, a first TDRA entry indicated in a first TDRA field.

In some examples, the TDRA manager 1030 may identify, based on the DCI message, a second TDRA entry indicated in a second TDRA field. In some examples, the TDRA manager 1030 may determine, based on the first TDRA entry and the second TDRA entry, that the first uplink channel on the first CC at least partially overlaps in time with the second uplink channel on the second CC. In some examples, the TDRA manager 1030 may identify a first TDRA field in the DCI message indicating a first uplink transmission timing for the first CC and a second TDRA field in the DCI message indicating a second uplink transmission timing, where the first uplink transmission timing at least partially overlaps in time with the second uplink transmission timing.

The UCI multiplexing manager 1035 may multiplex the UCI with the uplink data transmission on the first CC or the second CC based on a subset of fields indicated in the DCI message.

The time overlap manager 1040 may determine, based on the DCI message, that the first uplink channel on the first CC at least partially overlaps in time with the second uplink channel on the second CC. In some cases, the first uplink channel at least partially overlapping in time with the second uplink channel includes the first uplink channel fully overlapping the second uplink channel, and the second uplink channel fully overlapping the first uplink channel. In some cases, the first uplink channel uses a first symbol duration, and the second uplink channel uses a second symbol duration different than the first symbol duration. In some cases, the first subset of fields associated with the first CC and the second subset of fields associated with the second CC indicate a same set of values.

In some cases, one of the first subset of fields associated with the first CC or the second subset of fields associated with the second CC are used to multiplex the UCI and the uplink data transmission. In some cases, the first subset of fields associated with the first CC is used to multiplex the UCI and the uplink data transmission and the second subset of fields associated with the second CC indicate a fixed set of values.

In some cases, the second subset of fields associated with the second CC is used to multiplex the UCI and the uplink data transmission and the first subset of fields associated with the first CC indicate a fixed set of values. In some cases, the first subset of fields associated with the first CC is used to multiplex the UCI and the uplink data transmission and the second subset of fields associated with the second CC are configured as complementary bits. In some cases, the second subset of fields associated with the second CC is used to multiplex the UCI and the uplink data transmission and the first subset of fields associated with the first CC are configured as complementary bits.

FIG. 11 shows a diagram of a system 1100 including a device 1105 that supports uplink DCI for scheduling multiple CCs in accordance with aspects of the present disclosure. The device 1105 may be an example of or include the components of device 805, device 905, or a UE 115 as described herein. The device 1105 may include components for bi-directional voice and data communications including components for transmitting and receiving communications, including a communications manager 1110, an I/O controller 1115, a transceiver 1120, an antenna 1125, memory 1130, and a processor 1140. These components may be in electronic communication via one or more buses (e.g., bus 1145).

The communications manager 1110 may receive a DCI message associated with scheduling uplink transmissions from the UE on a set of CCs, determine, based on the DCI message indicating that a first uplink channel on a first CC of the set of CCs at least partially overlaps in time with a second uplink channel on a second CC of the set of CCs, that UCI multiplexing is supported for the uplink transmissions, multiplex, based on the determining, UCI with an uplink data transmission on the first CC or the second CC, and transmit the UCI and the uplink data transmission multiplexed on the first CC or the second CC.

The communications manager 1110 may also receive a DCI message associated with scheduling uplink transmissions from the UE on a set of CCs, determine, based on the DCI message indicating that a first uplink channel on a first CC of the set of CCs and a second uplink channel on a second CC of the set of CCs, that UCI multiplexing is supported for the uplink transmissions, multiplex, based on the determining, UCI with an uplink data transmission on the first CC according to a first subset of fields associated with the first CC in the DCI message or with the uplink data transmission on the second CC according to a second subset of fields associated with the second CC in the DCI message, and transmit the UCI and the uplink data transmission multiplexed on the first CC or the second CC.

The I/O controller 1115 may manage input and output signals for the device 1105. The I/O controller 1115 may also manage peripherals not integrated into the device 1105. In some cases, the I/O controller 1115 may represent a physical connection or port to an external peripheral. In some cases, the I/O controller 1115 may utilize an operating system such as iOS®, ANDROID®, MS-DOS®, MS-WINDOWS®, OS/2®, UNIX®, LINUX®, or another known operating system. In other cases, the I/O controller 1115 may represent or interact with a modem, a keyboard, a mouse, a touchscreen, or a similar device. In some cases, the I/O controller 1115 may be implemented as part of a processor. In some cases, a user may interact with the device 1105 via the I/O controller 1115 or via hardware components controlled by the I/O controller 1115.

The transceiver 1120 may communicate bi-directionally, via one or more antennas, wired, or wireless links as described above. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include random access memory (RAM) and read-only memory (ROM). The memory 1130 may store computer-readable, computer-executable code 1135 including instructions that, when executed, cause the processor to perform various functions described herein. In some cases, the memory 1130 may contain, among other things, a basic input/output system (BIOS) which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting uplink DCI for scheduling multiple CCs).

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

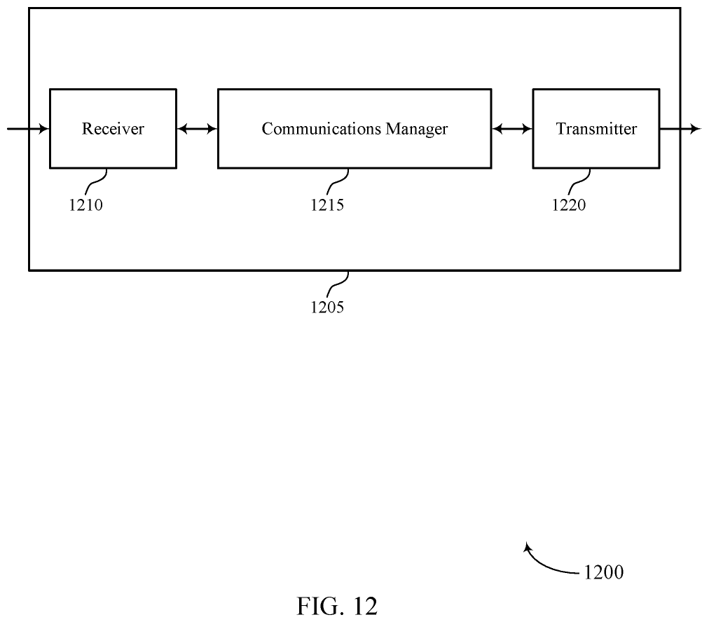

FIG. 12 shows a block diagram 1200 of a device 1205 that supports uplink DCI for scheduling multiple CCs in accordance with aspects of the present disclosure. The device 1205 may be an example of aspects of a base station 105 as described herein. The device 1205 may include a receiver 1210, a communications manager 1215, and a transmitter 1220. The device 1205 may also include a processor. Each of these components may be in communication with one another (e.g., via one or more buses).

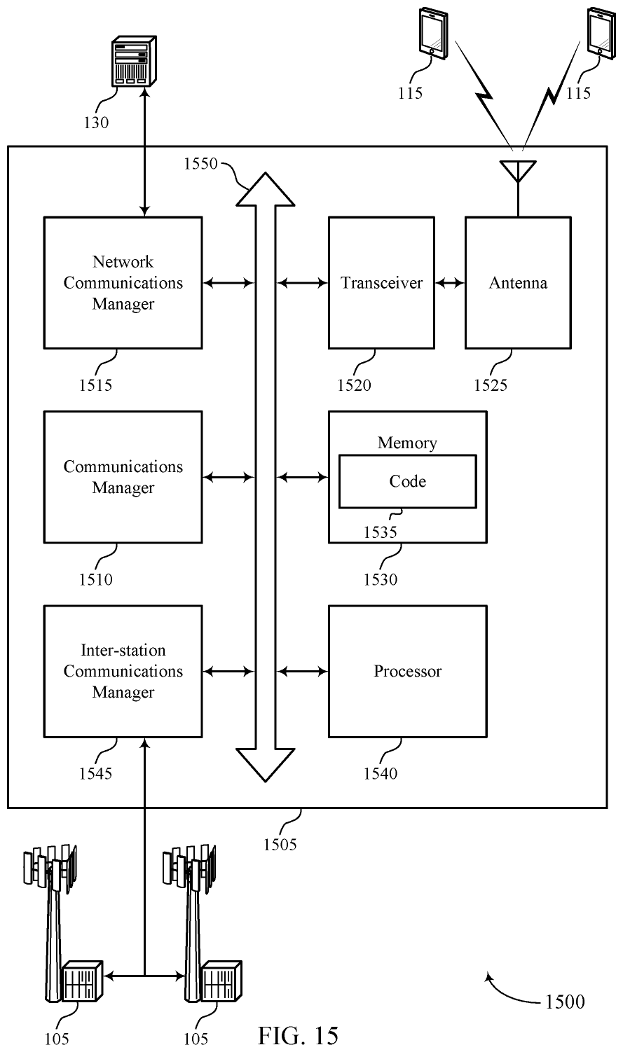

The receiver 1210 may receive information such as packets, user data, or control information associated with various information channels (e.g., control channels, data channels, and information related to uplink DCI for scheduling multiple CCs, etc.). Information may be passed on to other components of the device 1205. The receiver 1210 may be an example of aspects of the transceiver 1520 described with reference to FIG. 15. The receiver 1210 may utilize a single antenna or a set of antennas.

The communications manager 1215 may transmit a DCI message associated with scheduling uplink transmissions from the UE on the set of CCs, the DCI message indicating that a first uplink channel on a first CC of the set of CCs at least partially overlaps in time with a second uplink channel on a second CC of the set of CCs to indicate that UCI multiplexing is supported for the uplink data transmission, and receive the UCI and the uplink data transmission multiplexed on the first CC or the second CC based at least in part on the DCI message.

The communications manager 1215 may also configure a first subset of fields associated with a first CC in a DCI message or a second subset of fields associated with a second CC in the DCI message to indicate multiplexing information for multiplexing UCI with an uplink data transmission on the first CC or with the uplink data transmission on the second CC, transmit, to a UE, the DCI message associated with scheduling uplink transmissions from the UE on a set of CCs, the DCI message indicating that a first uplink channel on the first CC of the set of CCs and a second uplink channel on a second CC of the set of CCs are configured to indicate that UCI multiplexing is supported for the uplink transmissions, and receive the UCI and the uplink data transmission multiplexed on the first CC or the second CC based at least in part on the DCI message. The communications manager 1215 may be an example of aspects of the communications manager 1510 described herein.

The communications manager 1215, or its sub-components, may be implemented in hardware, code (e.g., software or firmware) executed by a processor, or any combination thereof. If implemented in code executed by a processor, the functions of the communications manager 1215, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The communications manager 1215, or its sub-components, may be physically located at various positions, including being distributed such that portions of functions are implemented at different physical locations by one or more physical components. In some examples, the communications manager 1215, or its sub-components, may be a separate and distinct component in accordance with various aspects of the present disclosure. In some examples, the communications manager 1215, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 1220 may transmit signals generated by other components of the device 1205. In some examples, the transmitter 1220 may be collocated with a receiver 1210 in a transceiver module. For example, the transmitter 1220 may be an example of aspects of the transceiver 1520 described with reference to FIG. 15. The transmitter 1220 may utilize a single antenna or a set of antennas.

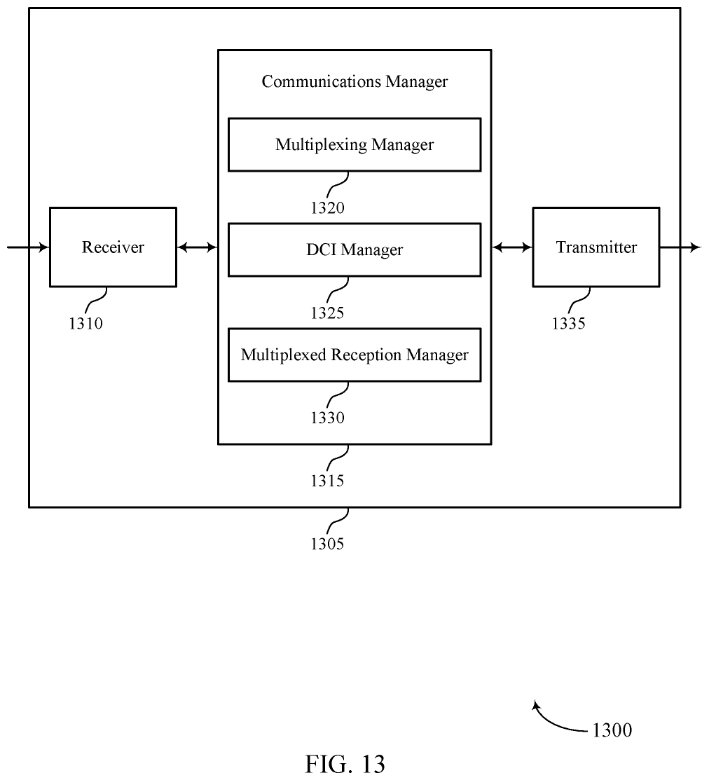

FIG. 13 shows a block diagram 1300 of a device 1305 that supports uplink DCI for scheduling multiple CCs in accordance with aspects of the present disclosure. The device 1305 may be an example of aspects of a device 1205, or a base station 105 as described herein. The device 1305 may include a receiver 1310, a communications manager 1315, and a transmitter 1335. The device 1305 may also include a processor. Each of these components may be in communication with one another (e.g., via one or more buses).

The receiver 1310 may receive information such as packets, user data, or control information associated with various information channels (e.g., control channels, data channels, and information related to uplink DCI for scheduling multiple CCs, etc.). Information may be passed on to other components of the device 1305. The receiver 1310 may be an example of aspects of the transceiver 1520 described with reference to FIG. 15. The receiver 1310 may utilize a single antenna or a set of antennas.

The communications manager 1315 may be an example of aspects of the communications manager 1215 as described herein. The communications manager 1315 may include a multiplexing manager 1320, a DCI manager 1325, and a multiplexed reception manager 1330. The communications manager 1315 may be an example of aspects of the communications manager 1510 described herein.

The multiplexing manager 1320 may determine, for a UE, that UCI and an uplink data transmission are to be multiplexed on a first CC or a second CC of a set of CCs.

The DCI manager 1325 may transmit a DCI message associated with scheduling uplink transmissions from the UE on the set of CCs, the DCI message indicating that a first uplink channel on a first CC of the set of CCs at least partially overlaps in time with a second uplink channel on a second CC of the set of CCs to indicate that UCI multiplexing is supported for the uplink data transmission.

The multiplexed reception manager 1330 may receive the UCI and the uplink data transmission multiplexed on the first CC or the second CC based at least in part on the DCI message.

The multiplexing manager 1320 may configure a first subset of fields associated with a first CC in a DCI message or a second subset of fields associated with a second CC in the DCI message to indicate multiplexing information for multiplexing UCI with an uplink data transmission on the first CC or with the uplink data transmission on the second CC.

The DCI manager 1325 may transmit, to a UE, the DCI message associated with scheduling uplink transmissions from the UE on a set of CCs, the DCI message indicating that a first uplink channel on the first CC of the set of CCs and a second uplink channel on a second CC of the set of CCs are configured to indicate that UCI multiplexing is supported for the uplink transmissions.

The multiplexed reception manager 1330 may receive the UCI and the uplink data transmission multiplexed on the first CC or the second CC based at least in part on the DCI message.

The transmitter 1335 may transmit signals generated by other components of the device 1305. In some examples, the transmitter 1335 may be collocated with a receiver 1310 in a transceiver module. For example, the transmitter 1335 may be an example of aspects of the transceiver 1520 described with reference to FIG. 15. The transmitter 1335 may utilize a single antenna or a set of antennas.

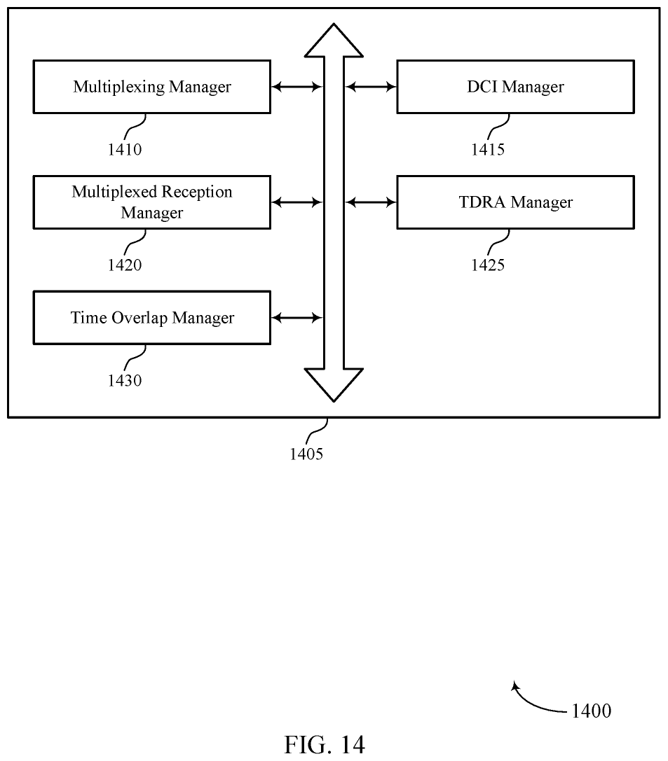

FIG. 14 shows a block diagram 1400 of a communications manager 1405 that supports uplink DCI for scheduling multiple CCs in accordance with aspects of the present disclosure. The communications manager 1405 may be an example of aspects of a communications manager 1215, a communications manager 1315, or a communications manager 1510 described herein. The communications manager 1405 may include a multiplexing manager 1410, a DCI manager 1415, a multiplexed reception manager 1420, a TDRA manager 1425, and a time overlap manager 1430. Each of these modules may communicate, directly or indirectly, with one another (e.g., via one or more buses).

The multiplexing manager 1410 may determine, for a UE, that UCI and an uplink data transmission are to be multiplexed on a first CC or a second CC of a set of CCs.

In some examples, the multiplexing manager 1410 may configure a first subset of fields associated with a first CC in a DCI message or a second subset of fields associated with a second CC in the DCI message to indicate multiplexing information for multiplexing UCI with an uplink data transmission on the first CC or with the uplink data transmission on the second CC. In some cases, the UCI includes acknowledgment feedback information, or channel state information, or a scheduling request, or a combination thereof. In some cases, the first uplink channel at least partially overlapping in time with the second uplink channel includes the first uplink channel fully overlapping at least a portion of the second uplink channel.

In some cases, the first uplink channel at least partially overlapping in time with the second uplink channel includes the first uplink channel fully overlapping the second uplink channel, and the second uplink channel fully overlapping the first uplink channel. In some cases, the first uplink channel uses a first symbol duration, and the second uplink channel uses a second symbol duration different than the first symbol duration. In some cases, the UCI includes acknowledgment feedback information, or channel state information, or a scheduling request, or a combination thereof.

In some cases, the first subset of fields include a first downlink assignment indicator field and a first beta offset field associated with the first CC. In some cases, the second subset of fields include a second downlink assignment indicator field and a second beta offset field associated with the second CC. In some cases, the first CC is configured as a time division duplexing carrier. In some cases, the second CC is configured as a frequency division duplexing carrier.

The DCI manager 1415 may transmit a DCI message associated with scheduling uplink transmissions from the UE on the set of CCs, the DCI message indicating that a first uplink channel on the first CC of the set of CCs at least partially overlaps in time with a second uplink channel on the second CC of the set of CCs to indicate that UCI multiplexing is supported for the uplink data transmission.

In some examples, the DCI manager 1415 may transmit, to a UE, the DCI message associated with scheduling uplink transmissions from the UE on a set of CCs, the DCI message indicating that a first uplink channel on the first CC of the set of CCs and a second uplink channel on a second CC of the set of CCs are configured to indicate that UCI multiplexing is supported for the uplink transmissions. In some examples, the DCI manager 1415 may configure a subset of fields indicate in the DCI message to indicate information associated with multiplexing the UCI with the uplink data transmission on the first CC or the second CC.

The multiplexed reception manager 1420 may receive the UCI and the uplink data transmission multiplexed on the first CC or the second CC. In some examples, the multiplexed reception manager 1420 may receive the UCI and the uplink data transmission multiplexed on the first CC or the second CC.

The TDRA manager 1425 may configure a TDRA field of the DCI message to indicate that the first uplink channel on the first CC at least partially overlaps in time with the second uplink channel on the second CC. In some examples, the TDRA manager 1425 may configure a first TDRA entry indicated in a first TDRA field in the DCI message.

In some examples, the TDRA manager 1425 may configure a second TDRA entry indicated in a second TDRA field in the DCI message, where the first TDRA entry and the second TDRA entry indicate that the first uplink channel on the first CC at least partially overlaps in time with the second uplink channel on the second CC. In some examples, the TDRA manager 1425 may configure a first TDRA field in the DCI message to indicate a first uplink transmission timing for the first CC and a second TDRA field in the DCI message to indicate a second uplink transmission timing, where the first uplink transmission timing at least partially overlaps in time with the second uplink transmission timing.

The time overlap manager 1430 may configure the DCI message to indicate that the first uplink channel on the first CC at least partially overlaps in time with the second uplink channel on a second CC. In some cases, the first subset of fields associated with the first CC and the second subset of fields associated with the second CC indicate a same set of values. In some cases, one of the first subset of fields associated with the first CC or the second subset of fields associated with the second CC are used by the UE to multiplex the UCI and the uplink data transmission.

In some cases, the first subset of fields associated with the first CC is used by the UE to multiplex the UCI and the uplink data transmission and the second subset of fields associated with the second CC indicate a fixed set of values. In some cases, the second subset of fields associated with the second CC is used by the UE to multiplex the UCI and the uplink data transmission and the first subset of fields associated with the first CC indicate a fixed set of values.

In some cases, the first subset of fields associated with the first CC is used to multiplex the UCI and the uplink data transmission and the second subset of fields associated with the second CC are configured as complementary bits. In some cases, the second subset of fields associated with the second CC is used to multiplex the UCI and the uplink data transmission and the first subset of fields associated with the first CC are configured as complementary bits.

FIG. 15 shows a diagram of a system 1500 including a device 1505 that supports uplink DCI for scheduling multiple CCs in accordance with aspects of the present disclosure. The device 1505 may be an example of or include the components of device 1205, device 1305, or a base station 105 as described herein. The device 1505 may include components for bi-directional voice and data communications including components for transmitting and receiving communications, including a communications manager 1510, a network communications manager 1515, a transceiver 1520, an antenna 1525, memory 1530, a processor 1540, and an inter-station communications manager 1545. These components may be in electronic communication via one or more buses (e.g., bus 1550).

The communications manager 1510 may determine, for a UE, that UCI and an uplink data transmission are to be multiplexed on a first CC or a second CC of a set of CCs, transmit a DCI message associated with scheduling uplink transmissions from the UE on the set of CCs, the DCI message indicating that a first uplink channel on the first CC of the set of CCs at least partially overlaps in time with a second uplink channel on the second CC of the set of CCs to indicate that UCI multiplexing is supported for the uplink data transmission, and receive the UCI and the uplink data transmission multiplexed on the first CC or the second CC.

The communications manager 1510 may also configure a first subset of fields associated with a first CC in a DCI message or a second subset of fields associated with a second CC in the DCI message to indicate multiplexing information for multiplexing UCI with an uplink data transmission on the first CC or with the uplink data transmission on the second CC, transmit, to a UE, the DCI message associated with scheduling uplink transmissions from the UE on a set of CCs, the DCI message indicating that a first uplink channel on the first CC of the set of CCs and a second uplink channel on a second CC of the set of CCs are configured to indicate that UCI multiplexing is supported for the uplink transmissions, and receive the UCI and the uplink data transmission multiplexed on the first CC or the second CC.

The network communications manager 1515 may manage communications with the core network (e.g., via one or more wired backhaul links). For example, the network communications manager 1515 may manage the transfer of data communications for client devices, such as one or more UEs 115.

The transceiver 1520 may communicate bi-directionally, via one or more antennas, wired, or wireless links as described above. For example, the transceiver 1520 may represent a wireless transceiver and may communicate bi-directionally with another wireless transceiver. The transceiver 1520 may also include a modem to modulate the packets and provide the modulated packets to the antennas for transmission, and to demodulate packets received from the antennas.

In some cases, the wireless device may include a single antenna 1525. However, in some cases the device may have more than one antenna 1525, which may be capable of concurrently transmitting or receiving multiple wireless transmissions.

The memory 1530 may include RAM, ROM, or a combination thereof. The memory 1530 may store computer-readable code 1535 including instructions that, when executed by a processor (e.g., the processor 1540) cause the device to perform various functions described herein. In some cases, the memory 1530 may contain, among other things, a BIOS which may control basic hardware or software operation such as the interaction with peripheral components or devices.

The processor 1540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some cases, a memory controller may be integrated into processor 1540. The processor 1540 may be configured to execute computer-readable instructions stored in a memory (e.g., the memory 1530) to cause the device 1505 to perform various functions (e.g., functions or tasks supporting uplink DCI for scheduling multiple CCs).

The inter-station communications manager 1545 may manage communications with other base station 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communication network technology to provide communication between base stations 105.

The code 1535 may include instructions to implement aspects of the present disclosure, including instructions to support wireless communications. The code 1535 may be stored in a non-transitory computer-readable medium such as system memory or other type of memory. In some cases, the code 1535 may not be directly executable by the processor 1540 but may cause a computer (e.g., when compiled and executed) to perform functions described herein.

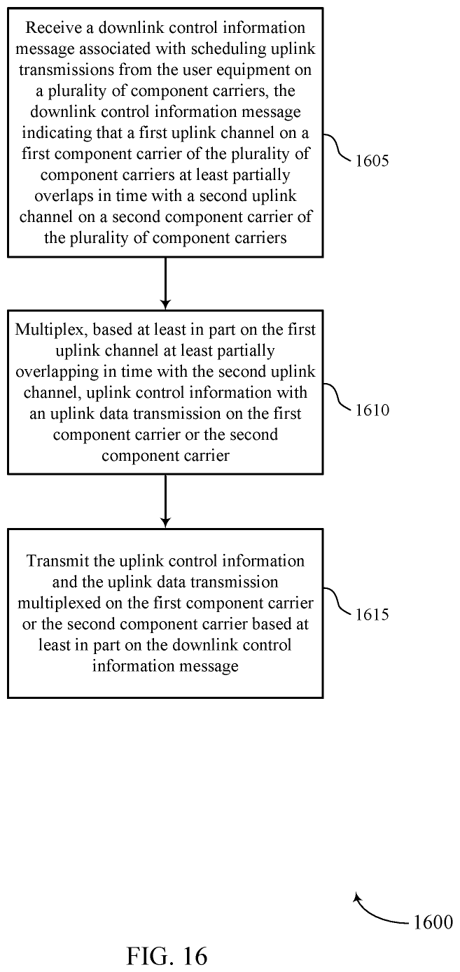

FIG. 16 shows a flowchart illustrating a method 1600 that supports uplink DCI for scheduling multiple CCs in accordance with aspects of the present disclosure. The operations of method 1600 may be implemented by a UE 115 or its components as described herein. For example, the operations of method 1600 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1605, the UE may receive a DCI message associated with scheduling uplink transmissions from the UE on a set of CCs, the DCI message indicating that a first uplink channel on a first CC of the set of CCs at least partially overlaps in time with a second uplink channel on a second CC of the set of CCs. The operations of 1605 may be performed according to the methods described herein. In some examples, aspects of the operations of 1605 may be performed by a DCI manager as described with reference to FIGS. 8 through 11.

At 1610, the UE may multiplex, based on the first uplink channel at least partially overlapping in time with the second uplink channel, UCI with an uplink data transmission on the first CC or the second CC. The operations of 1610 may be performed according to the methods described herein. In some examples, aspects of the operations of 1610 may be performed by a resource overlap manager as described with reference to FIGS. 8 through 11.

At 1615, the UE may transmit the UCI and the uplink data transmission multiplexed on the first CC or the second CC based at least in part on the DCI message. The operations of 1615 may be performed according to the methods described herein. In some examples, aspects of the operations of 1615 may be performed by a multiplexing manager as described with reference to FIGS. 8 through 11.

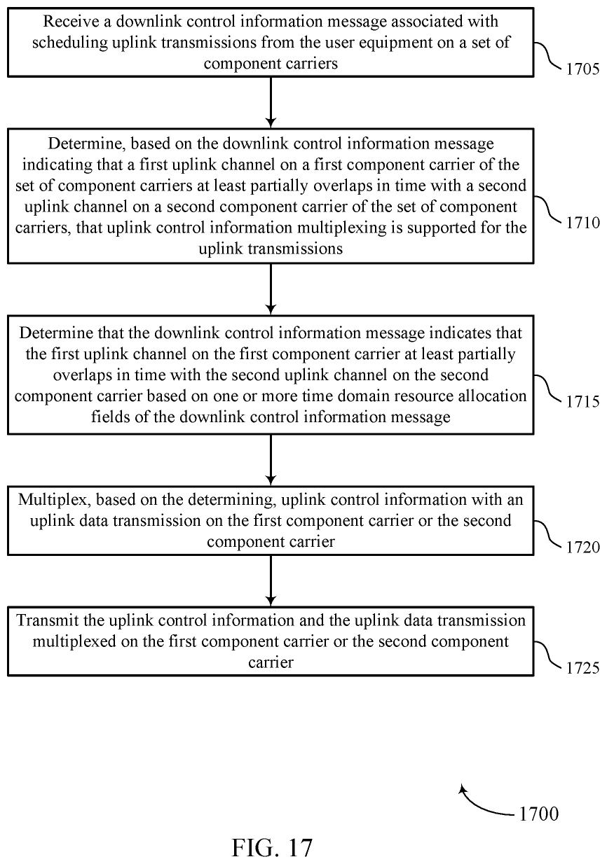

FIG. 17 shows a flowchart illustrating a method 1700 that supports uplink DCI for scheduling multiple CCs in accordance with aspects of the present disclosure. The operations of method 1700 may be implemented by a UE 115 or its components as described herein. For example, the operations of method 1700 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1705, the UE may receive a DCI message associated with scheduling uplink transmissions from the UE on a set of CCs. The operations of 1705 may be performed according to the methods described herein. In some examples, aspects of the operations of 1705 may be performed by a DCI manager as described with reference to FIGS. 8 through 11.

At 1710, the UE may determine, based on the DCI message indicating that a first uplink channel on a first CC of the set of CCs at least partially overlaps in time with a second uplink channel on a second CC of the set of CCs, that UCI multiplexing is supported for the uplink transmissions. The operations of 1710 may be performed according to the methods described herein. In some examples, aspects of the operations of 1710 may be performed by a resource overlap manager as described with reference to FIGS. 8 through 11.

At 1715, the UE may determine that the DCI message indicates that the first uplink channel on the first CC at least partially overlaps in time with the second uplink channel on the second CC based on one or more TDRA fields of the DCI message. The operations of 1715 may be performed according to the methods described herein. In some examples, aspects of the operations of 1715 may be performed by a TDRA manager as described with reference to FIGS. 8 through 11.

At 1720, the UE may multiplex, based on the determining, UCI with an uplink data transmission on the first CC or the second CC. The operations of 1720 may be performed according to the methods described herein. In some examples, aspects of the operations of 1720 may be performed by a multiplexing manager as described with reference to FIGS. 8 through 11.

At 1725, the UE may transmit the UCI and the uplink data transmission multiplexed on the first CC or the second CC. The operations of 1725 may be performed according to the methods described herein. In some examples, aspects of the operations of 1725 may be performed by a multiplexed transmission manager as described with reference to FIGS. 8 through 11.

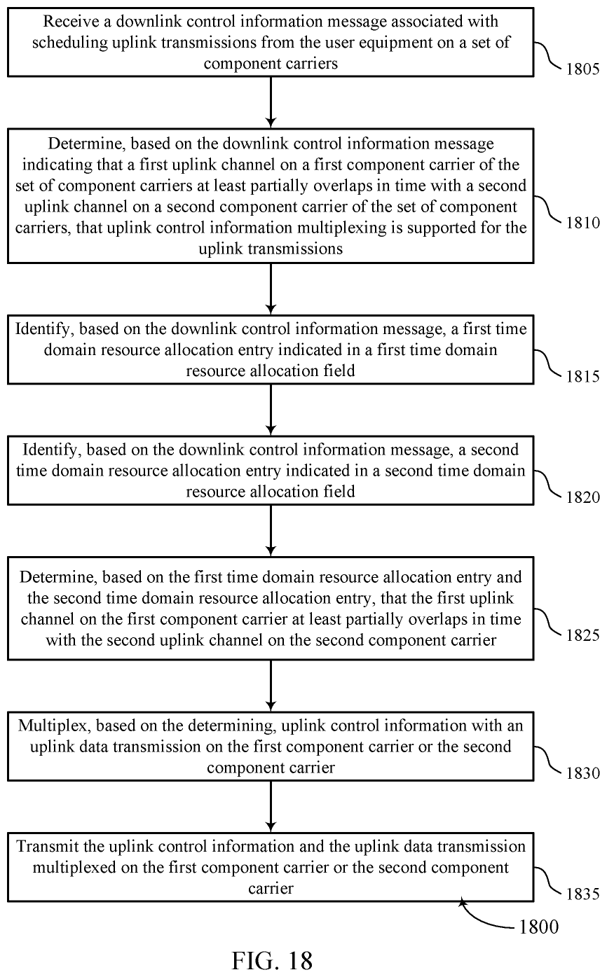

FIG. 18 shows a flowchart illustrating a method 1800 that supports uplink DCI for scheduling multiple CCs in accordance with aspects of the present disclosure. The operations of method 1800 may be implemented by a UE 115 or its components as described herein. For example, the operations of method 1800 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1805, the UE may receive a DCI message associated with scheduling uplink transmissions from the UE on a set of CCs. The operations of 1805 may be performed according to the methods described herein. In some examples, aspects of the operations of 1805 may be performed by a DCI manager as described with reference to FIGS. 8 through 11.

At 1810, the UE may determine, based on the DCI message indicating that a first uplink channel on a first CC of the set of CCs at least partially overlaps in time with a second uplink channel on a second CC of the set of CCs, that UCI multiplexing is supported for the uplink transmissions. The operations of 1810 may be performed according to the methods described herein. In some examples, aspects of the operations of 1810 may be performed by a resource overlap manager as described with reference to FIGS. 8 through 11.

At 1815, the UE may identify, based on the DCI message, a first TDRA entry indicated in a first TDRA field. The operations of 1815 may be performed according to the methods described herein. In some examples, aspects of the operations of 1815 may be performed by a TDRA manager as described with reference to FIGS. 8 through 11.

At 1820, the UE may identify, based on the DCI message, a second TDRA entry indicated in a second TDRA field. The operations of 1820 may be performed according to the methods described herein. In some examples, aspects of the operations of 1820 may be performed by a TDRA manager as described with reference to FIGS. 8 through 11.

At 1825, the UE may determine, based on the first TDRA entry and the second TDRA entry, that the first uplink channel on the first CC at least partially overlaps in time with the second uplink channel on the second CC. The operations of 1825 may be performed according to the methods described herein. In some examples, aspects of the operations of 1825 may be performed by a TDRA manager as described with reference to FIGS. 8 through 11.

At 1830, the UE may multiplex, based on the determining, UCI with an uplink data transmission on the first CC or the second CC. The operations of 1830 may be performed according to the methods described herein. In some examples, aspects of the operations of 1830 may be performed by a multiplexing manager as described with reference to FIGS. 8 through 11.

At 1835, the UE may transmit the UCI and the uplink data transmission multiplexed on the first CC or the second CC. The operations of 1835 may be performed according to the methods described herein. In some examples, aspects of the operations of 1835 may be performed by a multiplexed transmission manager as described with reference to FIGS. 8 through 11.

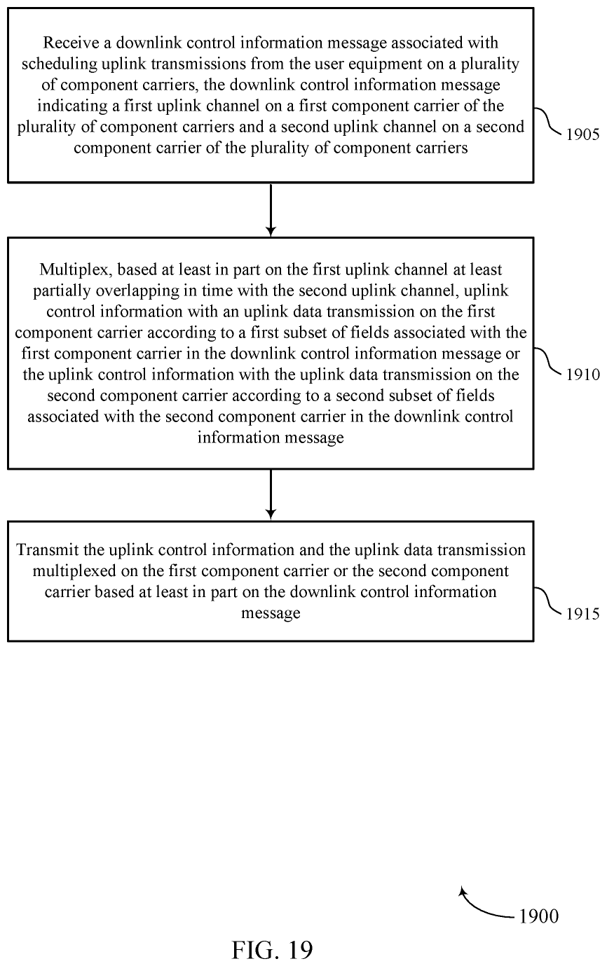

FIG. 19 shows a flowchart illustrating a method 1900 that supports uplink DCI for scheduling multiple CCs in accordance with aspects of the present disclosure. The operations of method 1900 may be implemented by a UE 115 or its components as described herein. For example, the operations of method 1900 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1905, the UE may receive a DCI message associated with scheduling uplink transmissions from the UE on a set of CCs, the DCI message indicating a first uplink channel on a first CC of the set of CCs and a second uplink channel on a second CC of the set of CCs. The operations of 1905 may be performed according to the methods described herein. In some examples, aspects of the operations of 1905 may be performed by a DCI manager as described with reference to FIGS. 8 through 11.

At 1910, the UE may multiplex, based at least in part on the first uplink channel at least partially overlapping in time with the second uplink channel, UCI with an uplink data transmission on the first CC according to a first subset of fields associated with the first CC in the DCI message or the UCI with the uplink data transmission on the second CC according to a second subset of fields associated with the second CC in the DCI message. The operations of 1910 may be performed according to the methods described herein. In some examples, aspects of the operations of 1910 may be performed by a multiplexing manager as described with reference to FIGS. 8 through 11.

At 1915, the UE may transmit the UCI and the uplink data transmission multiplexed on the first CC or the second CC based at least in part on the DCI message. The operations of 1915 may be performed according to the methods described herein. In some examples, aspects of the operations of 1915 may be performed by a multiplexing manager as described with reference to FIGS. 8 through 11.

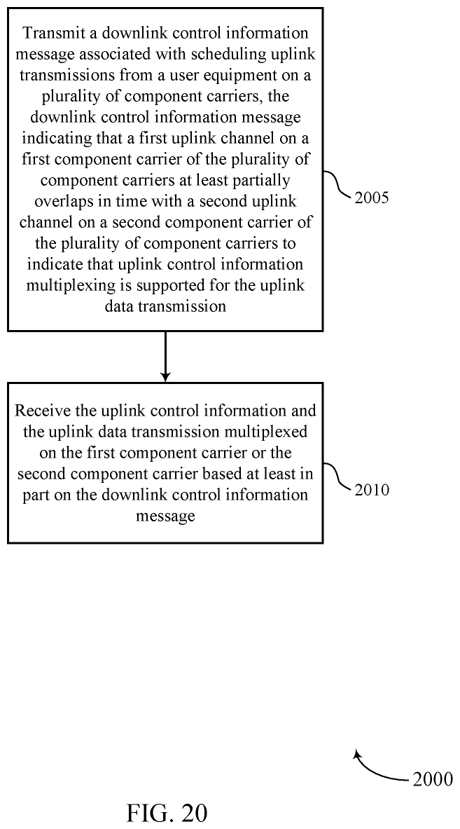

FIG. 20 shows a flowchart illustrating a method 2000 that supports uplink DCI for scheduling multiple CCs in accordance with aspects of the present disclosure. The operations of method 2000 may be implemented by a base station 105 or its components as described herein. For example, the operations of method 2000 may be performed by a communications manager as described with reference to FIGS. 12 through 15. In some examples, a base station may execute a set of instructions to control the functional elements of the base station to perform the functions described below. Additionally or alternatively, a base station may perform aspects of the functions described below using special-purpose hardware.

At 2005, the base station may transmit a DCI message associated with scheduling uplink transmissions from the UE on the set of CCs, the DCI message indicating that a first uplink channel on a first CC of the set of CCs at least partially overlaps in time with a second uplink channel on a second CC of the set of CCs to indicate that UCI multiplexing is supported for the uplink data transmission. The operations of 2005 may be performed according to the methods described herein. In some examples, aspects of the operations of 2005 may be performed by a multiplexing manager as described with reference to FIGS. 12 through 15.

At 2010, the base station may receive the UCI and the uplink data transmission multiplexed on the first CC or the second CC based at least in part on the DCI message. The operations of 2010 may be performed according to the methods described herein. In some examples, aspects of the operations of 2010 may be performed by a DCI manager as described with reference to FIGS. 12 through 15.

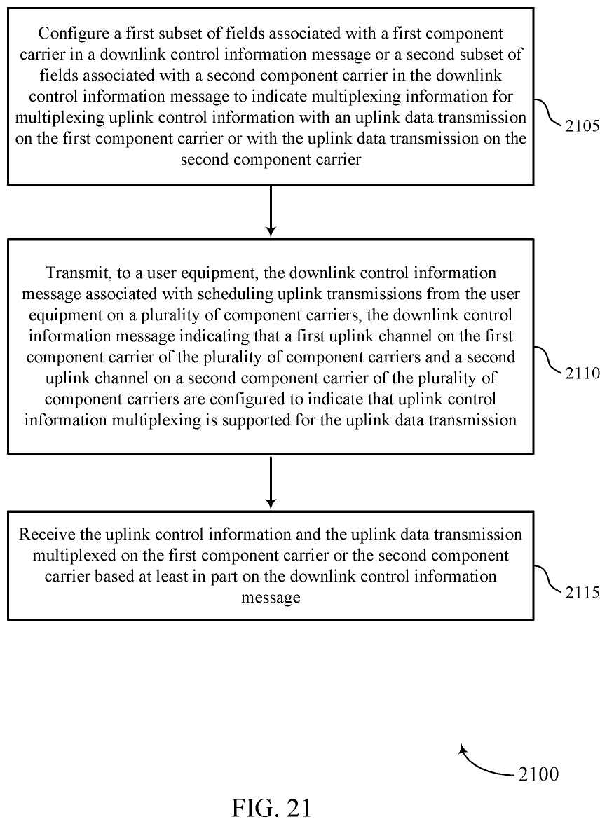

FIG. 21 shows a flowchart illustrating a method 2100 that supports uplink DCI for scheduling multiple CCs in accordance with aspects of the present disclosure. The operations of method 2100 may be implemented by a base station 105 or its components as described herein. For example, the operations of method 2100 may be performed by a communications manager as described with reference to FIGS. 12 through 15. In some examples, a base station may execute a set of instructions to control the functional elements of the base station to perform the functions described below. Additionally or alternatively, a base station may perform aspects of the functions described below using special-purpose hardware.

At 2105, the base station may configure a first subset of fields associated with a first CC in a DCI message or a second subset of fields associated with a second CC in the DCI message to indicate multiplexing information for multiplexing UCI with an uplink data transmission on the first CC or with the uplink data transmission on the second CC. The operations of 2105 may be performed according to the methods described herein. In some examples, aspects of the operations of 2105 may be performed by a multiplexing manager as described with reference to FIGS. 12 through 15.

At 2110, the base station may transmit, to a UE, the DCI message associated with scheduling uplink transmissions from the UE on a set of CCs, the DCI message indicating that a first uplink channel on the first CC of the set of CCs and a second uplink channel on a second CC of the set of CCs are configured to indicate that UCI multiplexing is supported for the uplink transmissions. The operations of 2110 may be performed according to the methods described herein. In some examples, aspects of the operations of 2110 may be performed by a DCI manager as described with reference to FIGS. 12 through 15.

At 2115, the base station may receive the UCI and the uplink data transmission multiplexed on the first CC or the second CC based at least in part on the DCI message. The operations of 2115 may be performed according to the methods described herein. In some examples, aspects of the operations of 2115 may be performed by a multiplexed reception manager as described with reference to FIGS. 12 through 15.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communication at a UE, comprising: receiving a downlink control information message associated with scheduling uplink transmissions from the UE on a plurality of component carriers, the downlink control information message indicating that a first uplink channel on a first component carrier of the plurality of component carriers at least partially overlaps in time with a second uplink channel on a second component carrier of the plurality of component carriers; multiplexing, based at least in part on the first uplink channel at least partially overlapping in time with the second uplink channel, uplink control information with an uplink data transmission on the first component carrier or the second component carrier; and transmitting the uplink control information and the uplink data transmission multiplexed on the first component carrier or the second component carrier based at least in part on the downlink control information message.

Aspect 2: The method of aspect 1, further comprising: determining that the downlink control information message indicates that the first uplink channel on the first component carrier at least partially overlaps in time with the second uplink channel on the second component carrier based at least in part on one or more time domain resource allocation fields of the downlink control information message.

Aspect 3: The method of any of aspects 1 through 2, further comprising: identifying, based at least in part on the downlink control information message, a first time domain resource allocation entry indicated in a first time domain resource allocation field; identifying, based at least in part on the downlink control information message, a second time domain resource allocation entry indicated in a second time domain resource allocation field; and determining, based at least in part on the first time domain resource allocation entry and the second time domain resource allocation entry, that the first uplink channel on the first component carrier at least partially overlaps in time with the second uplink channel on the second component carrier.

Aspect 4: The method of any of aspects 1 through 3, further comprising: identifying a first time domain resource allocation field in the downlink control information message indicating a first uplink transmission timing for the first component carrier and a second time domain resource allocation field in the downlink control information message indicating a second uplink transmission timing, wherein the first uplink transmission timing at least partially overlaps in time with the second uplink transmission timing.

Aspect 5: The method of any of aspects 1 through 4, further comprising: multiplexing the uplink control information with the uplink data transmission on the first component carrier or the second component carrier based at least in part on a subset of fields indicated in the downlink control information message.

Aspect 6: The method of any of aspects 1 through 5, wherein the uplink control information comprises acknowledgment feedback information, or channel state information, or a scheduling request, or a combination thereof.

Aspect 7: The method of any of aspects 1 through 6, wherein the first uplink channel at least partially overlapping in time with the second uplink channel comprises the first uplink channel fully overlapping at least a portion of the second uplink channel.

Aspect 8: The method of aspect 7, wherein the first uplink channel at least partially overlapping in time with the second uplink channel comprises the first uplink channel fully overlapping the second uplink channel, and the second uplink channel fully overlapping the first uplink channel.

Aspect 9: The method of any of aspects 1 through 8, wherein the first uplink channel uses a first symbol duration, and the second uplink channel uses a second symbol duration different than the first symbol duration.

Aspect 10: A method for wireless communication at a UE, comprising: receiving a downlink control information message associated with scheduling uplink transmissions from the UE on a plurality of component carriers, the downlink control information message indicating a first uplink channel on a first component carrier of the plurality of component carriers and a second uplink channel on a second component carrier of the plurality of component carriers; multiplexing, based at least in part on the first uplink channel at least partially overlapping in time with the second uplink channel, uplink control information with an uplink data transmission on the first component carrier according to a first subset of fields associated with the first component carrier in the downlink control information message or the uplink control information with the uplink data transmission on the second component carrier according to a second subset of fields associated with the second component carrier in the downlink control information message; and transmitting the uplink control information and the uplink data transmission multiplexed on the first component carrier or the second component carrier based at least in part on the downlink control information message.

Aspect 11: The method of aspect 10, further comprising: determining, based at least in part on the downlink control information message, that the first uplink channel on the first component carrier at least partially overlaps in time with the second uplink channel on the second component carrier.

Aspect 12: The method of aspect 11, wherein the first subset of fields associated with the first component carrier and the second subset of fields associated with the second component carrier indicate a same set of values.

Aspect 13: The method of any of aspects 11 through 12, wherein one of the first subset of fields associated with the first component carrier or the second subset of fields associated with the second component carrier are used to multiplex the uplink control information and the uplink data transmission.

Aspect 14: The method of any of aspects 11 through 13, wherein the first subset of fields associated with the first component carrier is used to multiplex the uplink control information and the uplink data transmission and the second subset of fields associated with the second component carrier indicate a fixed set of values.

Aspect 15: The method of any of aspects 11 through 14, wherein the second subset of fields associated with the second component carrier is used to multiplex the uplink control information and the uplink data transmission and the first subset of fields associated with the first component carrier indicate a fixed set of values.

Aspect 16: The method of any of aspects 11 through 15, wherein the first subset of fields associated with the first component carrier is used to multiplex the uplink control information and the uplink data transmission and the second subset of fields associated with the second component carrier are configured as complementary bits.

Aspect 17: The method of any of aspects 11 through 16, wherein the second subset of fields associated with the second component carrier is used to multiplex the uplink control information and the uplink data transmission and the first subset of fields associated with the first component carrier are configured as complementary bits.

Aspect 18: The method of any of aspects 10 through 17, wherein the uplink control information comprises acknowledgment feedback information, or channel state information, or a scheduling request, or a combination thereof.

Aspect 19: The method of any of aspects 10 through 18, wherein the first subset of fields comprise a first downlink assignment indicator field and a first beta offset field associated with the first component carrier; and the second subset of fields comprise a second downlink assignment indicator field and a second beta offset field associated with the second component carrier.

Aspect 20: The method of any of aspects 10 through 19, wherein the first component carrier is configured as a time division duplexing carrier; and the second component carrier is configured as a frequency division duplexing carrier.

Aspect 21: A method for wireless communication at a base station, comprising: transmitting a downlink control information message associated with scheduling uplink transmissions from a UE on a plurality of component carriers, the downlink control information message indicating that a first uplink channel on a first component carrier of the plurality of component carriers at least partially overlaps in time with a second uplink channel on a second component carrier of the plurality of component carriers to indicate that uplink control information multiplexing is supported for the uplink data transmission; and receiving the uplink control information and the uplink data transmission multiplexed on the first component carrier or the second component carrier based at least in part on the downlink control information message.

Aspect 22: The method of aspect 21, further comprising: configuring a time domain resource allocation field of the downlink control information message to indicate that the first uplink channel on the first component carrier at least partially overlaps in time with the second uplink channel on the second component carrier.

Aspect 23: The method of any of aspects 21 through 22, further comprising: configuring a first time domain resource allocation entry indicated in a first time domain resource allocation field in the downlink control information message; and configuring a second time domain resource allocation entry indicated in a second time domain resource allocation field in the downlink control information message, wherein the first time domain resource allocation entry and the second time domain resource allocation entry indicate that the first uplink channel on the first component carrier at least partially overlaps in time with the second uplink channel on the second component carrier.

Aspect 24: The method of any of aspects 21 through 23, further comprising: configuring a first time domain resource allocation field in the downlink control information message to indicate a first uplink transmission timing for the first component carrier and a second time domain resource allocation field in the downlink control information message to indicate a second uplink transmission timing, wherein the first uplink transmission timing at least partially overlaps in time with the second uplink transmission timing.

Aspect 25: The method of any of aspects 21 through 24, further comprising: configuring a subset of fields indicate in the downlink control information message to indicate information associated with multiplexing the uplink control information with the uplink data transmission on the first component carrier or the second component carrier.

Aspect 26: The method of any of aspects 21 through 25, wherein the uplink control information comprises acknowledgment feedback information, or channel state information, or a scheduling request, or a combination thereof.

Aspect 27: The method of any of aspects 21 through 26, wherein the first uplink channel at least partially overlapping in time with the second uplink channel comprises the first uplink channel fully overlapping at least a portion of the second uplink channel.

Aspect 28: The method of aspect 27, wherein the first uplink channel at least partially overlapping in time with the second uplink channel comprises the first uplink channel fully overlapping the second uplink channel, and the second uplink channel fully overlapping the first uplink channel.

Aspect 29: The method of any of aspects 21 through 28, wherein the first uplink channel uses a first symbol duration, and the second uplink channel uses a second symbol duration different than the first symbol duration.

Aspect 30: A method for wireless communication at a base station, comprising: configuring a first subset of fields associated with a first component carrier in a downlink control information message or a second subset of fields associated with a second component carrier in the downlink control information message to indicate multiplexing information for multiplexing uplink control information with an uplink data transmission on the first component carrier or with the uplink data transmission on the second component carrier; transmitting, to a UE, the downlink control information message associated with scheduling uplink transmissions from the UE on a plurality of component carriers, the downlink control information message indicating that a first uplink channel on the first component carrier of the plurality of component carriers and a second uplink channel on a second component carrier of the plurality of component carriers are configured to indicate that uplink control information multiplexing is supported for the uplink data transmission; and receiving the uplink control information and the uplink data transmission multiplexed on the first component carrier or the second component carrier based at least in part on the downlink control information message.

Aspect 31: The method of aspect 30, further comprising: configuring the downlink control information message to indicate that the first uplink channel on the first component carrier at least partially overlaps in time with the second uplink channel on a second component carrier.

Aspect 32: The method of aspect 31, wherein the first subset of fields associated with the first component carrier and the second subset of fields associated with the second component carrier indicate a same set of values.

Aspect 33: The method of any of aspects 31 through 32, wherein one of the first subset of fields associated with the first component carrier or the second subset of fields associated with the second component carrier are used by the UE to multiplex the uplink control information and the uplink data transmission.

Aspect 34: The method of any of aspects 31 through 33, wherein the first subset of fields associated with the first component carrier is used by the UE to multiplex the uplink control information and the uplink data transmission and the second subset of fields associated with the second component carrier indicate a fixed set of values.

Aspect 35: The method of any of aspects 31 through 34, wherein the second subset of fields associated with the second component carrier is used by the UE to multiplex the uplink control information and the uplink data transmission and the first subset of fields associated with the first component carrier indicate a fixed set of values.

Aspect 36: The method of any of aspects 31 through 35, wherein the first subset of fields associated with the first component carrier is used to multiplex the uplink control information and the uplink data transmission and the second subset of fields associated with the second component carrier are configured as complementary bits.

Aspect 37: The method of any of aspects 31 through 36, wherein the second subset of fields associated with the second component carrier is used to multiplex the uplink control information and the uplink data transmission and the first subset of fields associated with the first component carrier are configured as complementary bits.

Aspect 38: The method of any of aspects 30 through 37, wherein the uplink control information comprises acknowledgment feedback information, or channel state information, or a scheduling request, or a combination thereof.

Aspect 39: The method of any of aspects 30 through 38, wherein the first subset of fields comprise a first downlink assignment indicator field and a first beta offset field associated with the first component carrier; and the second subset of fields comprise a second downlink assignment indicator field and a second beta offset field associated with the second component carrier.

Aspect 40: The method of any of aspects 30 through 39, wherein the first component carrier is configured as a time division duplexing carrier; and the second component carrier is configured as a frequency division duplexing carrier.

Aspect 41: An apparatus for wireless communication at a UE, comprising a processor; memory coupled with the processor; and instructions stored in the memory and executable by the processor to cause the apparatus to perform a method of any of aspects 1 through 9.

Aspect 42: An apparatus for wireless communication at a UE, comprising at least one means for performing a method of any of aspects 1 through 9.

Aspect 43: A non-transitory computer-readable medium storing code for wireless communication at a UE, the code comprising instructions executable by a processor to perform a method of any of aspects 1 through 9.

Aspect 44: An apparatus for wireless communication at a UE, comprising a processor; memory coupled with the processor; and instructions stored in the memory and executable by the processor to cause the apparatus to perform a method of any of aspects 10 through 20.

Aspect 45: An apparatus for wireless communication at a UE, comprising at least one means for performing a method of any of aspects 10 through 20.

Aspect 46: A non-transitory computer-readable medium storing code for wireless communication at a UE, the code comprising instructions executable by a processor to perform a method of any of aspects 10 through 20.

Aspect 47: An apparatus for wireless communication at a base station, comprising a processor; memory coupled with the processor; and instructions stored in the memory and executable by the processor to cause the apparatus to perform a method of any of aspects 21 through 29.

Aspect 48: An apparatus for wireless communication at a base station, comprising at least one means for performing a method of any of aspects 21 through 29.

Aspect 49: A non-transitory computer-readable medium storing code for wireless communication at a base station, the code comprising instructions executable by a processor to perform a method of any of aspects 21 through 29.

Aspect 50: An apparatus for wireless communication at a base station, comprising a processor; memory coupled with the processor; and instructions stored in the memory and executable by the processor to cause the apparatus to perform a method of any of aspects 30 through 40.

Aspect 51: An apparatus for wireless communication at a base station, comprising at least one means for performing a method of any of aspects 30 through 40.

Aspect 52: A non-transitory computer-readable medium storing code for wireless communication at a base station, the code comprising instructions executable by a processor to perform a method of any of aspects 30 through 40.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein

What is claimed is:

1. A method for wireless communication at a user equipment (UE), comprising:
receiving a downlink control information message associated with scheduling uplink transmissions from the UE on a plurality of component carriers, the downlink control information message indicating that a first uplink channel on a first component carrier of the plurality of component carriers at least partially overlaps in time with a second uplink channel on a second component carrier of the plurality of component carriers;
multiplexing, based at least in part on the first uplink channel at least partially overlapping in time with the second uplink channel, uplink control information with an uplink data transmission on the first component carrier or the second component carrier; and
transmitting the uplink control information and the uplink data transmission multiplexed on the first component carrier or the second component carrier based at least in part on the downlink control information message.

2. The method of claim 1, further comprising:
determining that the downlink control information message indicates that the first uplink channel on the first component carrier at least partially overlaps in time with the second uplink channel on the second component carrier based at least in part on one or more time domain resource allocation fields of the downlink control information message.

3. The method of claim 1, further comprising:
identifying, based at least in part on the downlink control information message, a first time domain resource allocation entry indicated in a first time domain resource allocation field;
identifying, based at least in part on the downlink control information message, a second time domain resource allocation entry indicated in a second time domain resource allocation field; and
determining, based at least in part on the first time domain resource allocation entry and the second time domain resource allocation entry, that the first uplink channel on the first component carrier at least partially overlaps in time with the second uplink channel on the second component carrier.

4. The method of claim 1, further comprising:
identifying a first time domain resource allocation field in the downlink control information message indicating a first uplink transmission timing for the first component carrier and a second time domain resource allocation field in the downlink control information message indicating a second uplink transmission timing, wherein the first uplink transmission timing at least partially overlaps in time with the second uplink transmission timing.

5. The method of claim 1, further comprising:
multiplexing the uplink control information with the uplink data transmission on the first component carrier or the second component carrier based at least in part on a subset of fields indicated in the downlink control information message.

6. The method of claim 1, wherein the uplink control information comprises acknowledgment feedback information, or channel state information, or a scheduling request, or a combination thereof.

7. The method of claim 1, wherein the first uplink channel at least partially overlapping in time with the second uplink channel comprises the first uplink channel fully overlapping at least a portion of the second uplink channel.

8. The method of claim 7, wherein the first uplink channel at least partially overlapping in time with the second uplink channel comprises the first uplink channel fully overlapping the second uplink channel, and the second uplink channel fully overlapping the first uplink channel

9. The method of claim 1, wherein the first uplink channel uses a first symbol duration, and the second uplink channel uses a second symbol duration different than the first symbol duration.

10. A method for wireless communication at a user equipment (UE), comprising:
receiving a downlink control information message associated with scheduling uplink transmissions from the UE on a plurality of component carriers, the downlink control information message indicating a first uplink channel on a first component carrier of the plurality of component carriers and a second uplink channel on a second component carrier of the plurality of component carriers;
multiplexing, based at least in part on the first uplink channel at least partially overlapping in time with the second uplink channel, uplink control information with an uplink data transmission on the first component carrier according to a first subset of fields associated with the first component carrier in the downlink control information message or the uplink control information with the uplink data transmission on the second component carrier according to a second subset of fields associated with the second component carrier in the downlink control information message; and
transmitting the uplink control information and the uplink data transmission multiplexed on the first component carrier or the second component carrier based at least in part on the downlink control information message.

11. The method of claim 10, further comprising:
determining, based at least in part on the downlink control information message, that the first uplink channel on the first component carrier at least partially overlaps in time with the second uplink channel on the second component carrier.

12. The method of claim 11, wherein the first subset of fields associated with the first component carrier and the second subset of fields associated with the second component carrier indicate a same set of values.

13. The method of claim 11, wherein one of the first subset of fields associated with the first component carrier or the second subset of fields associated with the second component carrier are used to multiplex the uplink control information and the uplink data transmission.

14. The method of claim 11, wherein the first subset of fields associated with the first component carrier is used to multiplex the uplink control information and the uplink data transmission and the second subset of fields associated with the second component carrier indicate a fixed set of values.

15. The method of claim 11, wherein the second subset of fields associated with the second component carrier is used to multiplex the uplink control information and the uplink data transmission and the first subset of fields associated with the first component carrier indicate a fixed set of values.

16. The method of claim 11, wherein the first subset of fields associated with the first component carrier is used to multiplex the uplink control information and the uplink data transmission and the second subset of fields associated with the second component carrier are configured as complementary bits.

17. The method of claim 11, wherein the second subset of fields associated with the second component carrier is used to multiplex the uplink control information and the uplink data transmission and the first subset of fields associated with the first component carrier are configured as complementary bits.

18. The method of claim 10, wherein the uplink control information comprises acknowledgment feedback information, or channel state information, or a scheduling request, or a combination thereof.

19. The method of claim 10, wherein:
the first subset of fields comprise a first downlink assignment indicator field and a first beta offset field associated with the first component carrier; and
the second subset of fields comprise a second downlink assignment indicator field and a second beta offset field associated with the second component carrier.

20. The method of claim 10, wherein:
the first component carrier is configured as a time division duplexing carrier; and
the second component carrier is configured as a frequency division duplexing carrier.

21. An apparatus for wireless communication at a user equipment (UE), comprising:
a processor,
memory coupled with the processor; and
instructions stored in the memory and executable by the processor to cause the apparatus to:
receive a downlink control information message associated with scheduling uplink transmissions from the UE on a plurality of component carriers, the downlink control information message indicating that a first uplink channel on a first component carrier of the plurality of component carriers at least partially overlaps in time with a second uplink channel on a second component carrier of the plurality of component carriers;
multiplex, based at least in part on the first uplink channel at least partially overlapping in time with the second uplink channel, uplink control information with an uplink data transmission on the first component carrier or the second component carrier; and
transmit the uplink control information and the uplink data transmission multiplexed on the first component carrier or the second component carrier based at least in part on the downlink control information message.

22. The apparatus of claim 21, wherein the instructions are further executable by the processor to cause the apparatus to:
determine that the downlink control information message indicates that the first uplink channel on the first component carrier at least partially overlaps in time with the second uplink channel on the second component carrier based at least in part on one or more time domain resource allocation fields of the downlink control information message.

23. The apparatus of claim 21, wherein the instructions are further executable by the processor to cause the apparatus to:
identify, based at least in part on the downlink control information message, a first time domain resource allocation entry indicated in a first time domain resource allocation field;
identify, based at least in part on the downlink control information message, a second time domain resource allocation entry indicated in a second time domain resource allocation field; and
determine, based at least in part on the first time domain resource allocation entry and the second time domain resource allocation entry, that the first uplink channel on the first component carrier at least partially overlaps in time with the second uplink channel on the second component carrier.

24. The apparatus of claim 21, wherein the instructions are further executable by the processor to cause the apparatus to:
identify a first time domain resource allocation field in the downlink control information message indicating a first uplink transmission timing for the first component carrier and a second time domain resource allocation field in the downlink control information message indicating a second uplink transmission timing, wherein the first uplink transmission timing at least partially overlaps in time with the second uplink transmission timing.

25. The apparatus of claim 21, wherein the instructions are further executable by the processor to cause the apparatus to:
multiplex the uplink control information with the uplink data transmission on the first component carrier or the second component carrier based at least in part on a subset of fields indicated in the downlink control information message.

26. The apparatus of claim 21, wherein the first uplink channel at least partially overlapping in time with the second uplink channel comprises the first uplink channel fully overlapping at least a portion of the second uplink channel.

27. An apparatus for wireless communication at a user equipment (UE), comprising:
a processor,
memory coupled with the processor; and
instructions stored in the memory and executable by the processor to cause the apparatus to:
receive a downlink control information message associated with scheduling uplink transmissions from the UE on a plurality of component carriers, the downlink control information message indicating a first uplink channel on a first component carrier of the plurality of component carriers and a second uplink channel on a second component carrier of the plurality of component carriers;
multiplex, based at least in part on the first uplink channel at least partially overlapping in time with the second uplink channel, uplink control information with an uplink data transmission on the first component carrier according to a first subset of fields associated with the first component carrier in the downlink control information message or the uplink control information with the uplink data transmission on the second component carrier according to a second subset of fields associated with the second component carrier in the downlink control information message; and
transmit the uplink control information and the uplink data transmission multiplexed on the first component carrier or the second component carrier based at least in part on the downlink control information message.

28. The apparatus of claim 27, wherein the instructions are further executable by the processor to cause the apparatus to:
determine, based at least in part on the downlink control information message, that the first uplink channel on the first component carrier at least partially overlaps in time with the second uplink channel on the second component carrier.

29. The apparatus of claim 27, wherein the first subset of fields associated with the first component carrier and the second subset of fields associated with the second component carrier indicate a same set of values.

30. The apparatus of claim 27, wherein one of the first subset of fields associated with the first component carrier or the second subset of fields associated with the second component carrier are used to multiplex the uplink control information and the uplink data transmission.
